(19) United States
(12) Patent Application Publication
(10) Pub. No.: US 2026/0147530 A1
(43) Pub. Date: May 28, 2026

(54) CONFIGURABLE MULTI-BAND HOME THEATRE ARCHITECTURE

(71) Applicant: Sonos, Inc., Goleta, CA (US)

(72) Inventors: Cheng Lu, Malden, MA (US); Hrishikesh Gossain, Santa Barbara, CA (US); Lawrence Stefani, Andover, MA (US); Zhaoyun Huang, Sudbury, MA (US)

(21) Appl. No.: 19/114,675

(22) PCT Filed: Sep. 26, 2023
(86) PCT No.: PCT/US2023/075126

§ 371 Date: Mar. 24, 2025

Related U.S. Application Data
(60) Provisional application No. 63/377,216, filed on Sep. 27, 2022.
(60) Provisional application No. 63/377,222, filed on Sep. 27, 2022.

(51) Int. Cl. G06F 3/16; H04N 21/436; H04R 5/02; H04R 5/04; H04S 3/00

(52) U.S. Cl. CPC G06F 3/165; G06F 3/162; H04R 5/02; H04R 5/04; H04S 3/008; H04N 21/43615; H04R 2420/07; H04S 2400/01

(57) ABSTRACT

A playback device comprising a radio circuitry comprising a first radio and a second radio, at least one antenna coupled to the radio circuitry. The playback device configured to, while in a group comprising a plurality of satellite playback devices, connect, using a first radio of the playback device, to a first wireless network, establish, using a second radio of the playback device, a second wireless network, receive an audio stream including multi-channel audio content, communicate at least one first audio channel of the multi-channel audio content to a first subset of satellite playback devices over the first wireless network, and communicate at least one second audio channel of the multi-channel audio content to a second subset of satellite playback devices over the second wireless network. The playback device may be configured to coordinate playback of multi-channel audio content by satellite playback device(s) connected to a first wireless network established using a first radio, to coordinate including to transmit data representing audio channel(s) of the multi-channel audio content to the satellite device(s) over the first wireless network, to receive a first swap signal indicating to transition playback to a portable playback device, while connected to a second wireless network established using a second radio and without interfering with the second wireless network, modify the first wireless network to enable the portable playback device to connect to the first wireless network, form a synchrony group including the portable playback device and the satellite device(s) to cause the portable playback device to start playing the multi-channel audio content, and to remove the satellite device(s) from the synchrony group to stop playback of the multi-channel audio content on the satellite device(s).

### CROSS-REFERENCE TO RELATED APPLICATIONS

This application claims priority under 35 U.S.C. § 119(e), PCT Article 8, and Article 4 of the Paris Convention to co-pending U.S. Provisional Application No. 63/377,216 filed on Sep. 27, 2022 and titled “CONFIGURABLE MULTI-BAND HOME THEATRE ARCHITECTURE” and to co-pending U.S. Provisional Application No. 63/377,222 filed on Sep. 27, 2022 and titled “CONFIGURABLE MULTI-BAND HOME THEATER ARCHITECTURE,” each of which is incorporated herein by reference in its entirety for all purposes.

### FIELD OF THE DISCLOSURE

The present disclosure is related to consumer goods and, more particularly, to methods, systems, products, aspects, services, and other elements directed to media playback or some aspect thereof.

### BACKGROUND

Options for accessing and listening to digital audio in an out-loud setting were limited until 2002 when Sonos, Inc. began the development of a new type of playback system. Sonos then filed one of its first patent applications in 2003, titled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1A is a partial cutaway view of an example of an environment having a media playback system, in accordance with aspects of the disclosure;

FIG. 1B is a schematic diagram of an example of the media playback system of FIG. 1A and one or more networks, in accordance with aspects of the disclosure;

FIG. 1C is a block diagram of an example of a playback device, in accordance with aspects of the disclosure;

FIG. 1D is a block diagram of an example of a playback device, in accordance with aspects of the disclosure;

FIG. 1E is a block diagram of an example of a bonded playback device, in accordance with aspects of the disclosure;

FIG. 1F is a block diagram of an example of a network microphone device, in accordance with aspects of the disclosure;

FIG. 1G is a block diagram of an example of a playback device, in accordance with aspects of the disclosure;

FIG. 1H is a partially schematic diagram of an example of a control device, in accordance with aspects of the disclosure;

FIGS. 1I through 1L are schematic diagrams of corresponding media playback system zones, in accordance with various examples;

FIG. 1M is a schematic diagram of an example of media playback system areas, in accordance with aspects of the disclosure;

FIG. 2 is a diagram illustrating an example of a home theater environment, in accordance with aspects of the disclosure;

FIGS. 3A and 3B are diagrams each illustrating an example of a methodology that can be utilized by a primary device of the home theater environment to communicate audio content to satellite playback devices of the home theater environment, in accordance with aspects of the disclosure;

FIG. 4 is a diagram illustrating another example of a home theater environment, in accordance with aspects of the disclosure;

FIGS. 5A and 5B are diagrams each illustrating an example of a methodology that can be utilized by a primary device of the home theater environment to communicate audio content to satellite playback devices of the home theater environment, in accordance with aspects of the disclosure;

FIG. 6 is a flow diagram of one example of a method of configuring a bonded group in accordance with aspects of the disclosure;

FIG. 7 is a logical diagram of circuitry of an example of the primary device in accordance with aspects of the disclosure;

FIG. 8 is a flow diagram of one example of a method of performing a playback session swap in accordance with aspects of the disclosure;

FIG. 9 is a sequence diagram illustrating an example of information flow during a playback session swap procedure in accordance with aspects of the disclosure;

FIG. 10A is a front isometric view of one example of a portable playback device configured as headphones in accordance with aspects of the disclosure;

FIG. 10B is a front isometric view of another example of a portable playback device configured as headphones in accordance with aspects of the disclosure;

FIG. 10C is a front isometric view of another example of a portable playback device in accordance with aspects of the disclosure;

FIG. 11A is a diagram illustrating another example of a home theater environment in accordance with aspects of the disclosure; and

FIG. 11B is a diagram illustrating the example of the home theater environment of FIG. 11 in a swap mode in accordance with aspects of the disclosure.

### DETAILED DESCRIPTION

### I. Overview

Sonos Inc. has a long history of innovating in the home theater space as demonstrated by the successful launch of numerous home theater soundbar products including (but not limited to): PLAYBAR, PLAYBASE, RAY, BEAM, and ARC. Home theater systems have stringent latency requirements in order to maintain lip-synchrony between the audio being played back by the home theater system and the video content being displayed by a television. For example, when audio content associated with a frame of video content is received at a primary playback device (e.g., a soundbar) from the television over the Audio Return Channel (ARC) connection, the television will render that frame very soon thereafter (i.e., within milliseconds depending on the television and its operating mode). Accordingly, the home theater system must render the associated audio content at all satellite playback devices within a finite period of time (e.g., ˜40 milliseconds) from receipt in order to achieve lip synchrony. In that roughly 40 millisecond time window, the system needs to take the following actions: (1) decode the audio if encoded (e.g., using a format such as Dolby Digital format); (2) assign presentation times to the audio that specify when to render the audio to achieve synchrony between the primary playback device and the satellite playback devices; (3) transmit the audio to all the satellite playback devices; and (4) render the audio in accordance with the presentation times. Of those steps, transmission of the audio to all the satellite playback devices consumes a significant portion of the available time window (e.g., 20-25 milliseconds).

Accordingly, low-latency communication schemes may be implemented for wireless transmission of audio from the primary playback device (e.g., a soundbar) to one or more satellite playback devices (e.g., a subwoofer, a rear surround, etc.). In such a low-latency communication scheme, the satellite playback devices may connect to a dedicated wireless network established by the primary playback device for communication of audio for playback. By employing a dedicated network established by the primary playback device to communicate the audio traffic to the satellite playback devices, the audio traffic may be communicated directly to the satellite playback devices without the delay otherwise introduced by an intermediary hop across an Access Point (AP) (or other piece of networking equipment). Further, in certain implementations, the wireless network is configured as a 5 Gigahertz (GHz) WI-FI network (e.g., a WI-FI network that employs one or more wireless channels in the 5 GHz band for communication), which may offer additional latency benefits relative to a 2.4 GHz WI-FI network (e.g., a WI-FI network that employs one or more wireless channels in the 2.4 GHz band for communication) that typically suffers from considerable traffic congestion. To enable such a dedicated 5 GHz WI-FI network for transmission of audio content from the primary playback device to the satellite playback devices, the primary playback device may employ a dedicated radio to establish the dedicated WI-FI network. The primary playback device may employ a second radio configured to communicate over a backhaul connection to an AP (e.g., a user's AP in their home) so as to provide a communication path to other devices (e.g., user devices to facilitate control of the home theater system and/or cloud server(s) to obtain audio content for streaming). Additional details regarding low-latency communication schemes for home theater systems are described in U.S. Pat. No. 9,031,255 titled “Systems, Methods, Apparatus, and Articles of Manufacture to Provide Low-Latency Audio,” issued May 12, 2015, which is incorporated herein by reference in its entirety.

For home theater systems that employ a wireless network to transfer the audio to the requisite playback devices in the home theater system, the time spent packetizing and transmitting the audio content over the wireless network can be quite substantial (e.g., more than 10 milliseconds). Further, the time required to packetize and transmit the audio over the wireless network increases with the number of wireless speakers in the home theater system. For example, a home theater system that includes two playback devices communicating over the wireless network may need substantially less time to packetize and transmit all of the audio than a similar home theater system including four or more playback devices. As a result, conventional home theater systems that communicate the audio data over a wireless network typically meet the stringent latency requirements for lip-synchronization by severely limiting the number of playback devices in the home theater system to no more than four playback devices (e.g., a front soundbar, a subwoofer, a left rear speaker, and a right rear speaker).

Thus, for certain home theater implementations with a limited number of satellites, a low-latency communication scheme using a dedicated 5 GHz WI-FI network as discussed above is sufficient to allow the home theater system to render the received audio in lip-synchrony with the corresponding visual content displayed on the television. However, there is growing demand for home theater systems to support a greater number of satellite devices. For example, one popular configuration includes five dedicated satellites in addition to the primary playback device, namely, left and right front satellites, left and right rear satellites, and a sub-woofer. In addition, certain newer satellite playback devices may be capable of rendering multiple channels of audio, rather than only a single channel, which may substantially increase the amount of data needed to be transmitted and therefore, potentially increase the time required for transmission. For example, if a home theater system includes two higher-capability rear satellites each capable of rendering four channels of audio instead of two lower-capability rear satellites each only rendering one channel of audio, the amount of data needed to be transmitted to the two rear satellites has increased from two channels of audio to eight channels of audio (i.e., an increase of a factor of four). Without some system configuration change to handle this increased amount of data, the time for transmission of the audio content will also increase substantially. Should the transmission of audio content from the primary playback device to one or more satellite playback devices take too long, the audio content associated with a given section of visual content may not reach the satellite playback devices in time to be rendered in lip-synchrony with the visual content (e.g., reaching the one or more satellite playback devices more than 40 milliseconds after the visual content has been rendered).

One solution to this problem is to configure the primary device to support WI-FI 6 (and optionally WI-FI 6E) and be capable of establishing the dedicated WI-FI network as a 6 GHz wireless network (e.g., a WI-FI network that employs one or more wireless channels in the 6 GHz band for communication), which offers higher bandwidth for faster transmission of the audio data. However, in many home theater environments, not all the satellite playback devices may support WI-FI 6 and be capable of connecting to a 6 GHz WI-FI network. For example, a user may have a home theater set-up in which one or more satellite playback devices have WI-FI 6 capability (and potentially other enhanced features), but one or more other satellite playback devices do not. In such a scenario, the primary playback device cannot establish the dedicated wireless network as a 6 GHz wireless network because some of the satellite playback devices would be excluded. As a result, the user experience with their home theater system may be impaired because the user may be unable to use some of their available satellite playback devices (e.g., the system may support only four satellites instead of five) and/or may be unable to use certain enhanced features of one or more of their satellite playback devices (e.g., the capability to render multiple audio channels via a single satellite playback device).

Accordingly, aspects and embodiments disclosed herein relate to flexible networking techniques that enable a primary playback device to intelligently configure the dedicated wireless network for communication of audio data to the satellite playback devices based on the capabilities of the satellite playback devices and/or requirements for a given home theater set-up while also coordinating with the backhaul connection to the user's AP. In some embodiments, the primary playback device may be designed so as to be capable of simultaneously communicating over multiple frequency ranges in one or more WI-FI bands (e.g., the 2.4 GHz band, the 5 GHz band, and/or the 6 GHz band). As such, in certain examples, the primary playback device may be configured to use one radio to establish a first dedicated WI-FI network in one frequency range for communication with at least some of the satellite playback devices and, when needed, use the second radio to establish a second wireless network that coexists with the backhaul connection to the user's AP and can be used to communicate audio data to one or more satellites that are not connected to the first dedicated wireless network.

For example, as discussed in more detail below, the primary playback device may establish a first dedicated wireless network in the 6 GHz band for communicating with one or more satellite playback devices having WI-FI 6 capability, and establish a second dedicated wireless network in the 5 GHz band for communicating with one or more other satellite playback devices that do not have WI-FI 6 capability. Both the first and second dedicated wireless networks can be established in frequency ranges that do not overlap or interfere with the backhaul connection to the AP. In this manner, the primary playback device can be configured to intelligently allocate the satellite playback devices among the two dedicated wireless networks, while coordinating with the backhaul connection. This allows the system to achieve low-latency communications with the satellite playback devices, support and leverage enhanced features that may be available with newer and/or more capable satellite playback devices, while still allowing the user to use their older and/or less capable satellite playback devices without giving up the features and advantages associated with the newer and/or more capable satellites. In addition, the system may support more home theater configurations, including those that use five or more dedicated satellite playback devices.

In some embodiments, the primary playback device may be configured to simultaneously operate in multiple frequency ranges at least in part by splitting a band (e.g., the 5 GHz band) into multiple sub-bands. For instance, the primary device may split the 5 GHZ band into multiple sub-bands, such as 5 GHz High sub-band and 5 GHz Low sub-band. Each of these sub-bands may comprise a subset of the total number of available channels in the 5 GHz band (e.g., 5 GHz High may comprise those channels above a cutoff frequency in the 5 GHz band while 5 GHz Low may comprise those channels below that cutoff frequency in the 5 GHz frequency band). In some embodiments, the cutoff frequency may be at the center of the 5 GHz band such that the 5 GHz Low sub-band covers the lower half of the 5 GHz band and the 5 GHz High sub-band covers the upper half of the 5 GHz band.

By dividing the 5 GHz band into multiple sub-bands, the primary device may facilitate concurrent operation in the 5 GHz band of both the backhaul connection and a dedicated wireless network for communication of audio content to the satellites. For instance, the primary device may establish (e.g., using a first radio) a backhaul connection to a 5 GHZ WI-FI network established by an AP on a first channel in the 5 GHz band that is in the 5 GHZ Low sub-band and also establish (using the first radio) a 5 GHz WI-FI network for some of the satellite playback devices on a second, different channel in the 5 GHz band that is in the 5 GHZ High sub-band. In addition, the primary playback device may establish (e.g., using a second radio) a 6 GHz WI-FI network for others of the satellite playback devices. As a result, the primary playback device may concurrently communicate over the 6 GHz WI-FI network and two different 5 GHz WI-FI networks that are on different channels in different sub-bands. Other variations may be implemented, as discussed further below.

In some instances, the primary playback device may leverage this capability of simultaneous communication over multiple WI-FI networks to provide flexibility in accommodating satellite playback devices with different capabilities, providing backwards compatibility with older satellite playback devices while also supporting features (such as multi-channel audio playback) associated with newer satellite playback devices, and allowing more complex home theater configurations.

In addition, in certain circumstances it may be desirable to transition a playback session from a playback zone that includes one or more satellites operating in a home theater mode together with the primary device, as discussed above, to another satellite device, such as a portable device. For example, a user may begin a playback session using a home theater bonded group that includes the primary device and one or more satellite playback devices, wherein the primary device receives audio content from a television and transmits audio data to the one or more satellites as discussed above. The user may later decide to continue watching the television in a different location and/or using a different display device, which may also involve the user wishing to transition the audio from the home theater group of playback devices to a different satellite device, such as a portable device that the user may carry with them to the new location. In another example, the user may wish to continue watching the television, but transition the audio from the home theater group of playback devices to headphones so as not to disturb other people who may be nearby.

Accordingly, aspects and embodiments provide techniques for transitioning a playback session between a portable playback device (such as headphones or a battery-operated, carryable device, for example) and the playback devices of a zone-based media playback system (e.g., a home theater bonded group). Such transitions are referred to herein as “swaps” or “playback session swaps.” Swap techniques as disclosed herein may facilitate continuity of playback when transitioning between locations (e.g., from at home to on-the-go or vice versa) or between listening paradigms (e.g., personal or out-loud). Further, some swap techniques may reduce the extent of user input (or other user involvement) involved with transitioning playback as compared with some other techniques.

For many home theater configurations, once the home theater bonded group has been established, changes to the satellite playback devices included in the group may be relatively infrequent. Accordingly, once the primary device has determined the capabilities of the satellite playback devices in the group and allocated the satellite playback devices between the first and second radios, as discussed above, reevaluation of the configuration may not need to be performed very frequently. However, swap transitions between the home theater group and a portable playback device may occur at any time and with varying frequency. In addition, the portable playback device may be different for different playback session swaps. For example, one swap may occur from the home theater group and headphones, whereas another swap may occur from the home theater group to another type of portable playback device that may have different capabilities from the headphones. Further, since the portable device generally may not be part of the home theater group, the primary device may not “know” the capabilities of the portable device until it receives a notification of the presence of the portable device, such as an instruction to perform the swap, for example.

Accordingly, in certain embodiments, the primary device may be configured to dynamically evaluate and reconfigure one or both of the first and second wireless networks to accommodate a portable device as a “temporary satellite” when the primary device receives an indication that a playback session is to be transitioned to the portable device. As discussed further below, in certain examples, to initiate a playback session swap from the home theater group to the portable playback device, a user may provide an input to the portable playback device. This input designates the portable playback device as the target of the playback session swap. The source of the swap (i.e., the home theater group, for example) is determined based on context (i.e., based on an active playback session). In certain examples, based on the input, the portable playback device may transmit a “swap trigger” signal that can be detected by the primary device. The primary device may coordinate the playback session swap with the portable playback device, and playback of the television audio continues uninterrupted on the portable playback device.

According to certain embodiments, coordinating the playback session swap may include transitioning the satellite playback devices that are communicating with the primary device via the first dedicated wireless network established by the first radio onto the second wireless network established by the second radio. This allows the primary device to reconfigure the first wireless network to suit the portable playback device, while “parking” the home theater group satellite playback devices on the second wireless network such that one or more of the satellites can be easily and quickly transitioned back to the first wireless network when the user is ready to initiate (or return to) a home theater mode playback session. In certain examples, transitioning one or more satellite playback devices from the first wireless network to the second wireless network may involve reconfiguring one or more parameters of the second wireless network. This may be accomplished without disrupting or interfering with the backhaul connection. Similarly, reconfiguring the first wireless network to accommodate the portable playback device, as needed, may be accomplished without disrupting or interfering with either the backhaul connection or the second wireless network.

Thus, according to certain examples, the primary playback device may further leverage the capability of simultaneous communication over multiple WI-FI networks to provide flexibility in seamlessly accommodating temporary satellite playback devices that may be added to or removed from a playback session at any time.

According to certain embodiments, a primary playback device comprises radio circuitry including a first radio and a second radio, at least one antenna coupled to the radio circuitry, at least one processor, and at least one non-transitory computer-readable medium storing program instructions that are executable by the at least one processor to control the primary playback device to operate in a bonded group comprising the primary playback device and a plurality of satellite playback devices, to operate in the bonded group comprising to connect, using the first radio, to a first wireless network, establish, using the second radio, a second wireless network, receive an audio stream including multi-channel audio content, identify, based on one or more capabilities of the plurality of satellite playback devices, a first subset of the plurality of satellite playback devices and a second subset of the plurality of satellite playback devices, communicate at least one first audio channel of the multi-channel audio content to the first subset of satellite playback devices over the first wireless network, communicate at least one second audio channel of the multi-channel audio content to the second subset of satellite playback devices over the second wireless network, and render at least one third audio channel of the multi-channel audio content in synchrony with rendering of the at least one first audio channel by the first subset of satellite playback devices and rendering of the at least one second audio channel by the second subset of satellite playback devices.

According to further embodiments, a playback device comprises radio circuitry including a first radio and a second radio, at least one antenna coupled to the radio circuitry, at least one processor, and at least one non-transitory computer-readable medium storing program instructions that are executable by the at least one processor to control the playback device to operate in a bonded group including the playback device and one or more satellite playback devices, to operate in a bonded group comprising to coordinate a playback session including playback of multi-channel audio content by the one or more satellite playback devices, the one or more satellite playback devices being connected to a first wireless network established using the first radio, wherein to coordinate includes to transmit data representing one or more audio channels of the multi-channel audio content to the one or more satellite playback devices over the first wireless network, receive a first swap signal indicating to transition the playback session to a portable playback device, while connected to a second wireless network established using the second radio and without interfering with the second wireless network, modify the first wireless network based on at least a network capability of the portable playback device and one or more parameters of the second wireless network to enable the portable playback device to connect to the first wireless network, after the portable playback device has connected to the first wireless network, form (e.g., temporarily form) a first synchrony group including the portable playback device and the one or more satellite playback devices, wherein forming the first synchrony group causes the portable playback device to start playing the multi-channel audio content of the playback session via one or more transducers and one or more amplifiers, and after forming the first synchrony group (e.g., immediately afterwards), remove the one or more satellite playback devices from the first synchrony group to stop playback of the one or more audio channels of the multi-channel audio content on the one or more satellite playback devices. In certain examples, the at least one non-transitory computer-readable medium further comprises program instructions that are executable by the at least one processor to control the playback device to: transition the one or more satellite playback devices from the first wireless network onto the second wireless network.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

Many of the details, dimensions, angles and other aspects shown in the Figures are merely illustrative of particular embodiments of the disclosed technology. Accordingly, other embodiments can have other details, dimensions, angles, and aspects without departing from the spirit or scope of the disclosure. In addition, those of ordinary skill in the art will appreciate that further embodiments of the various disclosed technologies can be practiced without several of the details described below.

### II. Suitable Operating Environment

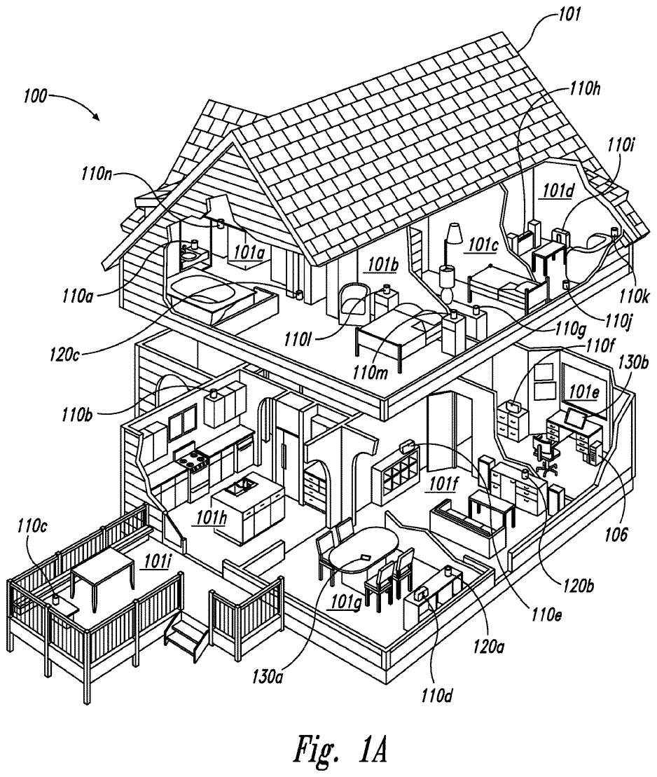

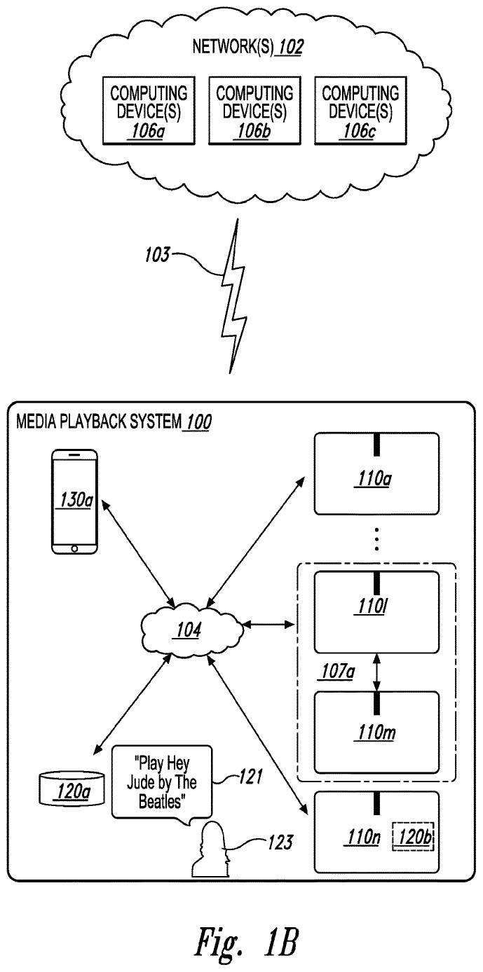

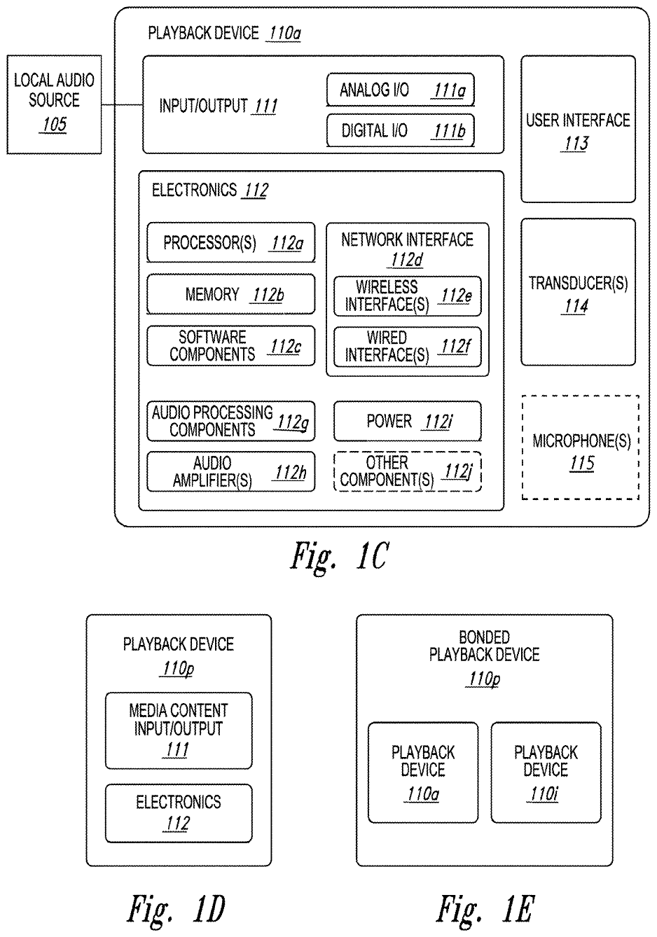

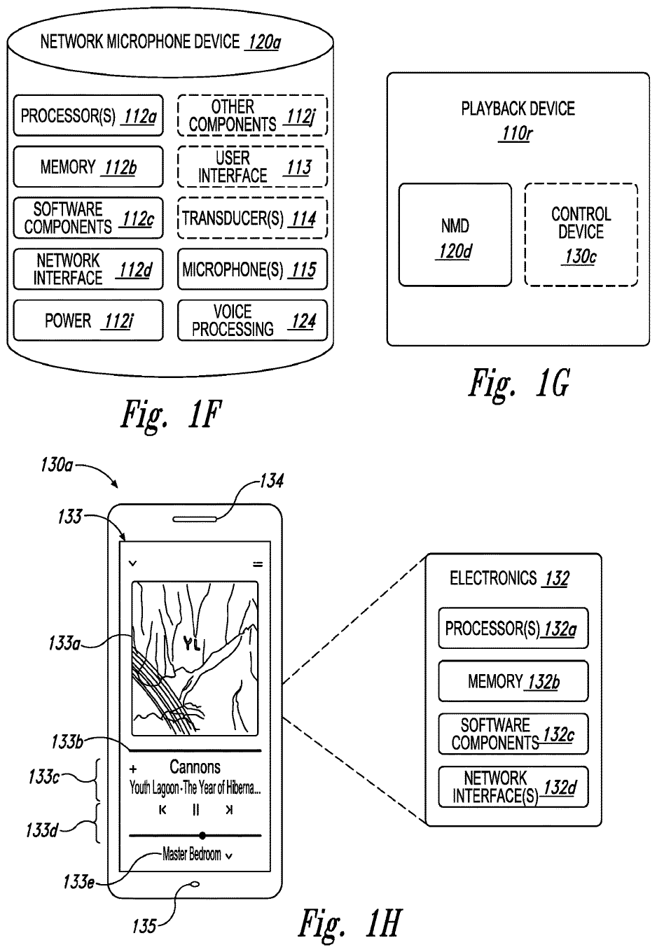

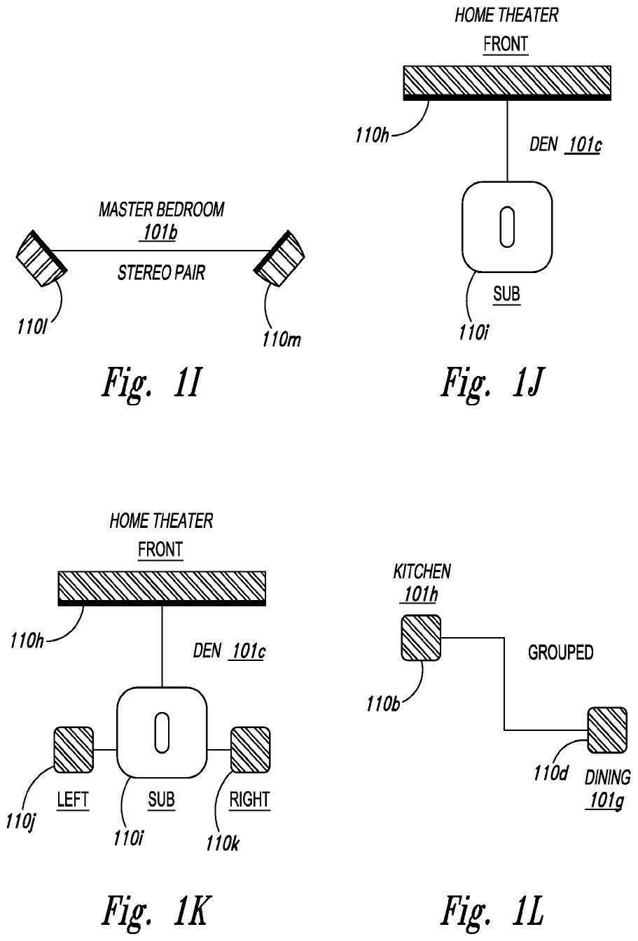

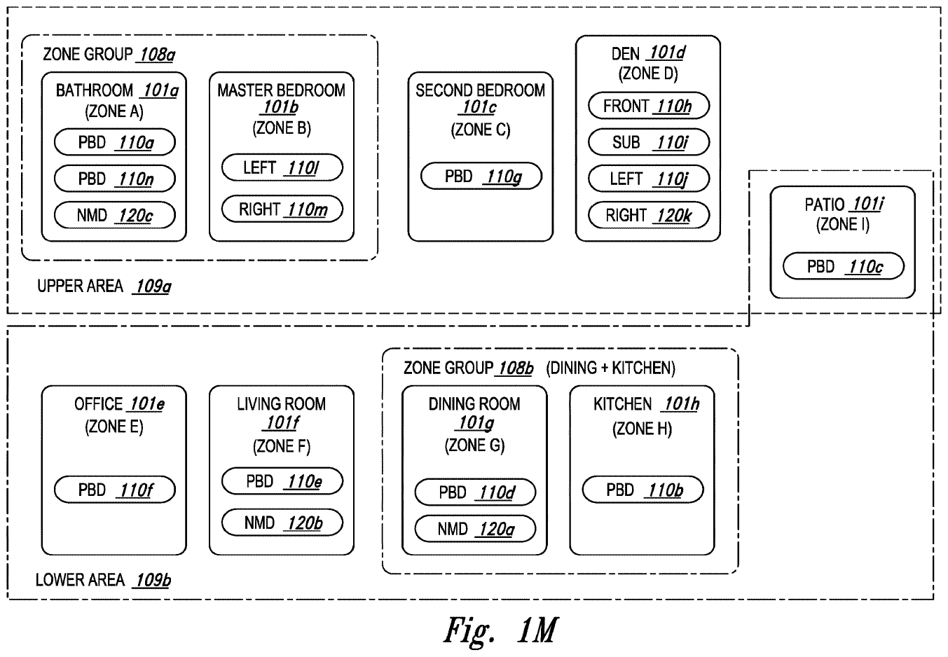

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-1M.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments, the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH, a Z-WAVE network, a ZIGBEE, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household WI-FI network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100. In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable data storage medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers.

Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low-frequency transducers (e.g., subwoofers, woofers), mid-range frequency transducers (e.g., mid-range transducers, mid-woofers), and one or more high-frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “AMP,” “PORT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high-frequency audio content, and the playback device 110i is a subwoofer configured to render low-frequency audio content. In some aspects, the playback device 110a, when bonded with the first playback device, is configured to render only the mid-range and high-frequency components of particular audio content, while the playback device 110i renders the low-frequency component of the particular audio content. In some embodiments, the bonded playback device 110q includes additional playback devices and/or another bonded playback device.

### C. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IOT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad) , a computer (e.g., a laptop computer, a desktop computer, etc.), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone, and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments, the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies, and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in U.S. Pat. No. 10,499,146 filed Feb. 21, 2017, and titled “Voice Control of a Media Playback System,” which is herein incorporated by reference in its entirety.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to a type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group.

Further examples of techniques for implementing Areas may be found, for example, in U.S. Pat. No. 10,712,997 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Examples of a Home Theater Environment and Operation

As noted above, playback devices that are bonded may have different playback responsibilities, such as responsibilities for certain audio channels. For example, as illustrated in FIG. 1K, in a home theater environment, the Front and SUB devices 110h and 110i can be bonded with Left and Right playback devices 110j and 110k, respectively. Further, in some implementations, the Right and Left devices 110j and 102k can be configured to form surround or “satellite” channels of a home theater system. The bonded playback devices 110h, 110i, 110j, and 110k may form a single Zone D (FIG. 1M).

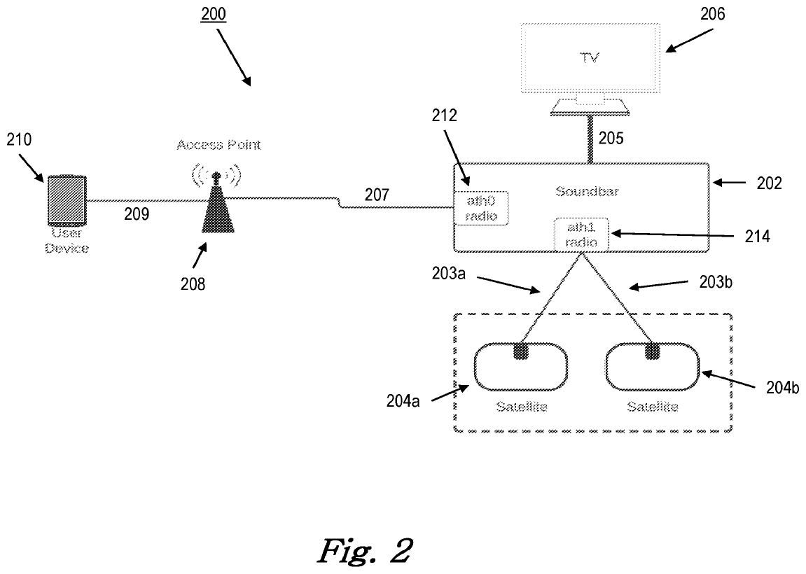

FIG. 2 illustrates an example of a home theater environment 200. As shown, the home theater environment 200 comprises a display device 206, such as a television or monitor, that displays visual content and outputs audio content (associated with the displayed visual content) via a communication link 205 to a primary device 202 (e.g., a soundbar, a smart TV box, a smart TV stick, etc.). The primary device 202 is capable of receiving audio via an audio input interface from a television, media player (e.g., set-top box, streaming media playback device, computer), or other home theater source. Further, the primary device may operate as a sourcing device for a bonded zone (e.g., a home theater group) that includes one or more satellites, which may play back certain channels (e.g., the playback devices 110j and 110k) and/or certain frequency ranges (e.g., the playback device 110i), as shown, for example, in FIGS. 1K and 1J illustrating the Den 101c. The primary device 202 includes a first radio 212 (referred as the “backhaul radio”) and, using the first radio, communicates with an access point (AP) 208 via a communication link 207 (e.g., a backhaul connection). Additionally, the primary device 202 includes a second radio 214 (referred as the “fronthaul radio”) and, using the second radio, communicates with one or more satellite playback devices 204 (shown as satellite playback devices 204a and 204b) via one or more communication links 203 (shown as communication links 203a and 203b), as discussed in more detail below. The AP 208, in turn, communicates with other devices such as a user device 210 (e.g., a smartphone, tablet, laptop, desktop computer, etc.) via communication link 209. In some examples, the primary device 202 may be integrated with the display device 206, for example a TV may include a smart soundbar.

In some instances, the home theater environment 200 may playback audio from a music streaming service. In such instances, the primary device 202 may communicate with one or more cloud servers associated with a music service provider (e.g., via the communication link 207 to the AP 208) to obtain the audio content for playback. After receipt of the audio content for playback, the primary device 202 may communicate the audio content (or any portion thereof) to the satellite playback devices 204 for synchronous playback via the communication links 203. In examples where the primary device 202 is implemented as a soundbar (or otherwise comprises transducers for rendering audio content), the primary device 202 may render the audio content in synchrony with the satellite playback devices 204. In such examples, the primary device 202 and the satellite playback devices 204 form a home theater bonded zone or group, as discussed above with reference to FIG. 1J, for example. In examples where the primary device 202 is implemented as a smart TV box or smart TV stick (or otherwise does not comprise transducers for rendering audio content), the satellite playback devices 204 may render the audio content in synchrony with each other while the primary device 202 may not render the audio content. In such examples, the satellite playback devices 404 form a home theater bonded zone.

In some instances, the primary device 202 and the satellite playback devices 204 may render audio content in lip-synchrony with associated visual content displayed by the display device 206. In such examples, the primary device 202 may receive audio content from the display device 206. For example, the primary device 202 and the display device 206 can include analog and/or digital interfaces that facilitate communicating the audio content (e.g., multi-channel audio content) such as a SPDIF RCA interface, an HDMI interface (e.g., audio return channel (ARC) HDMI interface), an optical interface (e.g., TOSLINK interface), etc. In such examples, the communication link 205 may comprise a wired connection (e.g., an SPDIF cable, an HDMI cable, a TOSLINK cable, etc.). In other examples, the primary device 202 and the display device 206 may include wireless circuitry that facilitates wirelessly communicating the audio content from the display device 206 to the primary device 202. In such examples, the communication link 205 may be a wireless communication link such as a WI-FI link, BLUETOOTH link, ZIGBEE link, Z-WAVE link, and/or wireless HDMI link.

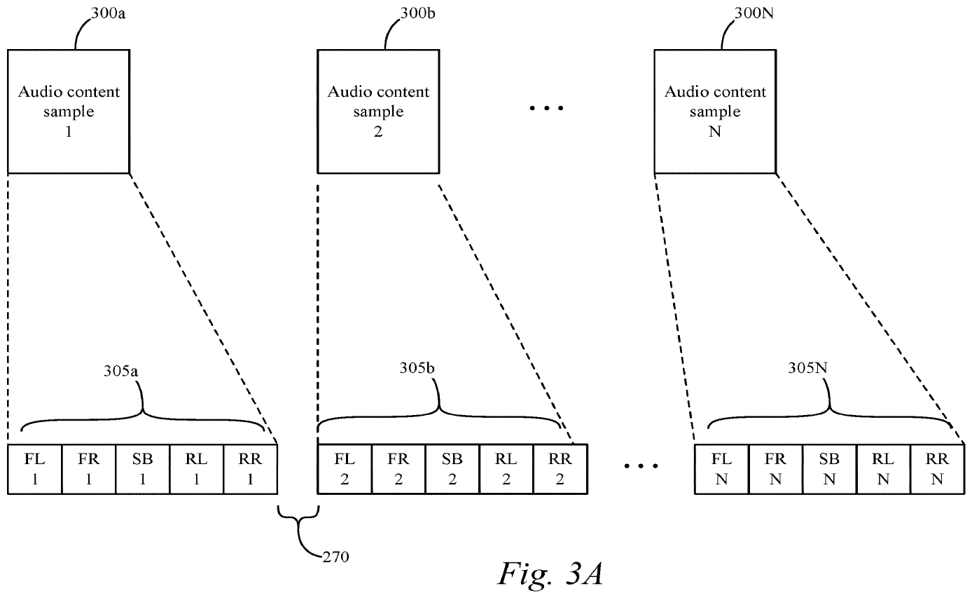

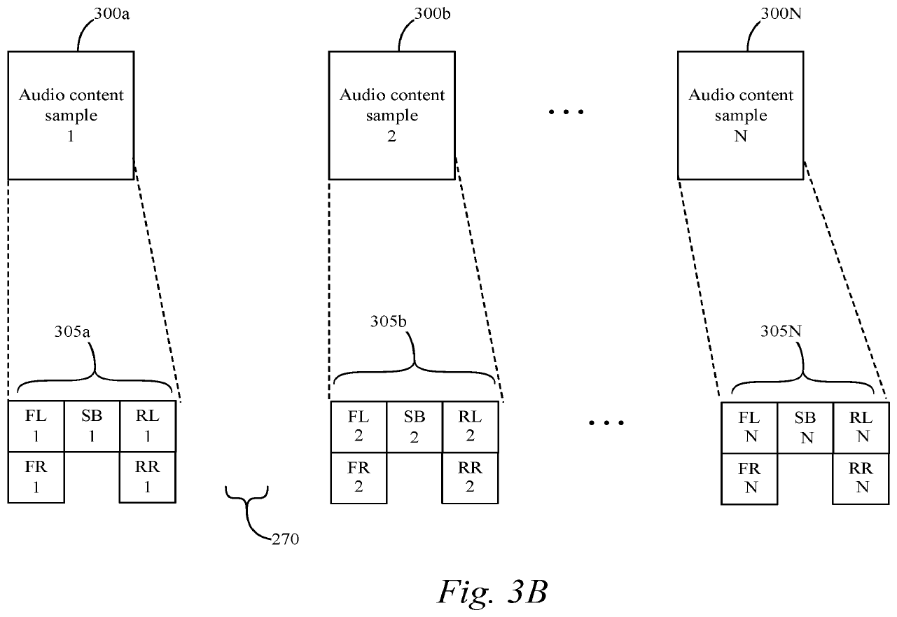

After receipt of the audio content associated with visual content to be rendered by the display device 206, the primary device 202 may communicate the received audio content (or any portion thereof) to the satellite playback devices 204 (e.g., via communication links 203). Any of a variety of methodologies may be employed to communicate the audio content to the satellite playback devices as described in more detail below with respect to FIGS. 3A and 3B. Once the audio content has been communicated to the satellite playback devices, the satellite playback devices 204 (and/or primary device 202) may render the audio content in synchrony with each other and in lip-synchrony with visual content displayed on the display device 206. For instance, in examples where the primary device 202 is implemented as a soundbar (or otherwise comprises transducers for rendering audio content), the primary device 202 may render the audio content in synchrony with the satellite playback devices 204 and in lip-synchrony with the visual content displayed on the display device 206. In examples where the primary device 202 is implemented as a smart TV box or smart TV stick (or otherwise does not comprise transducers for rendering audio content), the satellite playback devices 204 may render the audio content in synchrony with each other and in lip-synchrony with the display of visual content on the display device 206 while the primary device 202 may not render the audio content.

In some embodiments, the primary device 202 may also be configured to operate as an AP and/or as a router (e.g., a mesh router) that client devices (e.g., separate and apart from devices in the home theater environment) may be able to connect to for network access (e.g., access to a Wide Area Network (WAN) such as the Internet). For instance, the primary device 202 may be configured as a wireless mesh router that integrates into a mesh router system to extend the range of the mesh router system. Such mesh router systems are becoming increasingly advantageous with the deployment of countless Internet-of-Things (IoT) devices in spaces (e.g., residential and/or commercial spaces).

FIG. 3A illustrates an example of a methodology that can be utilized by the primary device 202 to communicate audio content to the satellite playback devices 204. In some instances, the primary device 202 can utilize a “Round Robin” scheduling approach to communicate the audio content to the satellite playback devices 204. For example, the primary device 202 can receive a stream of audio content samples (300a, 300b, . . . 300n) from the display device 206. The audio content samples 300 can be communicated from the display device 206 at any of a variety of rates including, for example, 44.1 kilohertz (kHz), 48 kHz, 96 kHz, 176.2 kHz, and 192 kHz. The audio content samples 300 may comprise uncompressed audio content (e.g., Pulse-Code Modulation (PCM) audio) and/or compressed audio content (e.g., DOLBY audio such as DOLBY AC-3 audio, DOLBY E-AC-3 audio, DOLBY AC-4 audio, and DOLBY ATMOS audio). The display device 206 outputs the audio content samples 300 while beginning the process of rendering the video content on a display (e.g., integrated into the display device 206). Given that the display device 206 may take tens of milliseconds to successfully render the video content, the audio content samples 300 may be output just before the corresponding video content is displayed (e.g., tens of milliseconds earlier). The primary device 202 may coordinate playback of the audio content samples 300 in lip-synchrony with the video content being displayed on the display device 206 such that there is no perceived audio delay (i.e., no lip-syncing issues are perceived) by the viewer. In this regard, it can be shown that in some cases, a delay of no more than 40 ms between the video content being rendered and the audio content being heard is imperceptible to the average viewer. The primary device 202 may achieve lip-synchrony by, for example, exploiting one or more of the following periods of time: (1) a gap between the display device 206 outputting the audio content samples 300 and display device 206 actually displaying the associated visual content; and/or (2) an allowable delay between the visual content being displayed and the associated audio content being played back without losing lip-synchrony (e.g., up to 40 milliseconds).

After receiving a particular audio content sample 300a, the primary device 202 can extract the channel samples 305a (i.e., front-left, front-right, etc.) from the audio content sample 300a and can communicate the channel samples 305a to the corresponding satellite playback devices 204. In the illustrated examples in FIG. 3A, the channel samples 305a are communicated sequentially. For example, during a first interval, the primary device 202 can communicate the front-left channel sample (FL1) associated with a first audio content sample 300a to a first satellite playback device assigned to render the front left channel. During a second interval, the primary device 202 can communicate the front-right channel sample (FR1) associated with the first audio content sample 300a to a second satellite playback device assigned to render the front right channel. During a third interval, the primary device 202 can communicate the subwoofer channel sample (SB1) associated with the first audio content sample 300a to a third satellite playback device assigned to render the subwoofer channel. During a fourth interval, the primary device 202 can communicate the rear-left channel sample (RL1) associated with the first audio content sample 300a to a fourth satellite playback device associated to render the rear-left channel. During a fifth interval, the primary device 202 can communicate the rear-right channel sample (RR1) associated with the first audio content sample 300a to a fifth satellite playback device assigned to render the rear-right channel. The same process can repeat with the arrival of subsequent audio content samples from the display device 206, such as audio content sample 300b through audio content sample 300n.

As discussed above, in certain examples, a single device (e.g., the primary device and/or any one or more of the satellite playback devices) may be assigned to render multiple audio channels simultaneously. As a result, a single transmission to a single satellite in accordance with the “Round-Robin” approach shown in FIG. 3A may comprise channel samples associated with multiple channels. For instance, a satellite playback device may be assigned to render both a right-rear channel and a height channel. In such an instance, a transmission to that satellite playback device may comprise a right-rear channel sample and a height channel sample for the satellite playback device to render.

Further, it should be appreciated that the primary device may communicate channel samples to multiple satellite playback devices 204 simultaneously. Simultaneous communication of audio content from the primary device 202 to the satellite playback devices 204 may be accomplished in any of a variety of ways. For example, certain wireless communication standards (e.g., 802.11ax, 802.11be, WI-FI 6, WI-FI 6E, and/or WI-FI 7) include orthogonal frequency-division multiple access (OFDMA) support that enables a given wireless channel to be subdivided into multiple smaller sub-channels. Each of these sub-channels may be employed to communicate with different devices independently from each other. In examples where the primary device 202 (and at least two of the satellite playback devices 204) support such a wireless communication standard, the primary device 202 may simultaneously transmit audio samples to two or more satellite playback devices 204 that support OFDMA. For example, the primary device may simultaneously transmit audio samples to a first satellite playback device 204a over a first sub-channel and transmit audio samples to a second satellite playback device 204b over a second sub-channel within the same channel as the first sub-channel.

In some instances, the satellite playback devices 204 may comprise a mix of one or more devices that support OFDMA (e.g., one or more devices that support 802.11ax, 802.11be, WI-FI 6, WI-FI 6E and/or WI-FI 7) and one or more devices that do not support OFDMA (e.g., one or more devices that support an older backwards-compatible standard such as 802.11n, 802.11ac, WI-FI 4, WI-FI 5, etc.). In such instances, the primary device 202 may combine transmission of channel samples to multiple OFDMA capable satellite playback devices into a fewer number of transmissions than there are OFDMA capable satellite playback devices (e.g., into one transmission) while individually transmitting the other channel samples to the set of devices that do not support OFDMA. For example, the satellite playback devices 204 may comprise four devices that support OFDMA and two devices that do not. In this example, the primary device 202 may make three transmissions for each audio content sample including: (1) a first transmission to all four of the OFDMA capable satellites; (2) a second transmission to the first non-OFDMA capable satellite; and (3) a third transmission to the second non-OFDMA capable satellite.

It should be appreciated that other techniques separate and apart from OFDMA may be employed to facilitate simultaneous communication of channel samples to satellite playback devices 204. For instance, the primary device 202 may simultaneously communicate with multiple satellite playback devices 204 using multiple wireless channels. For example, the channel samples 305a for a first subset of the satellite playback device can be communicated via a first RF channel and the channel samples 305a for a second subset of the satellite playback devices can be communicated via a second RF channel that is different from the first RF channel (e.g., a different channel in the same spectrum as the first RF channel or a different channel in a different spectrum than the first RF channel).

FIG. 3B illustrates an example of a methodology that can be utilized by the primary device 202 to communicate audio content to the satellite playback devices 204 that leverages the simultaneous communication capabilities described above. As shown, multiple channel samples may be transmitted simultaneously to multiple different satellite playback devices 204. For example, during a first interval, the primary device 202 can communicate both the front-left channel sample (FL1) associated with a first audio content sample 300a to a first satellite playback device and the front-right channel sample (FR1) associated with the first audio content sample 300a to a second satellite playback device. During a second interval, the primary device 202 can communicate the subwoofer channel sample (SB1) associated with the first audio content sample 300a to a third satellite playback device (i.e., a subwoofer satellite device). During a third interval, the primary device 202 can communicate both the rear-left channel sample (RL1) associated with the first audio content sample 300a to a fourth satellite playback device and the rear-right channel sample (RR1) associated with the first audio content sample 300a to a fifth satellite playback device. The same process can repeat with the arrival of subsequent audio content samples from the television 205, such as audio content sample 300b through audio content sample 300N.

It should be appreciated that the order in which the particular channel samples 305 are transmitted and the way in which the particular channel samples 305 are grouped for simultaneous transmission may vary based on the particular implementation. For example, the rear-left channel sample (RL1) and/or the rear-right channel sample (RR1) may be transmitted before the front-left channel sample (FL1) and/or the front-right channel sample (FR1). Additionally (or alternatively), the rear-left channel sample (RL1) may be transmitted simultaneously with the front-left channel sample (FL1) and/or the front-right channel sample (FR1). Thus, the particular channel samples 305a may be ordered and/or grouped in any of a variety of ways.

It should be noted that the amount of time required to communicate the channel samples 305 associated with a particular audio content sample 300 can depend on the number of channels encoded in the audio content sample 300 and/or the number of channels to be decoded from the audio content sample for playback by the satellite playback devices 204. For example, the total amount of time required to communicate the channel samples 305 may increase as the total number of channels increases. As discussed above, this increase in the total amount of time required to communicate the channel samples 305 can become problematic in home theater systems attempting to maintain lip-synchrony with video content being played back on the television 205. For example, the total amount of time required to communicate the requisite channel samples 305 for audio content with a large number of audio channels (e.g., DOLBY ATMOS audio content) may be longer than the available time window to render audio output in lip-synchrony.

Accordingly, aspects and embodiments disclosed herein provide techniques for leveraging the simultaneous communication capabilities of the primary device to address this problem and enable home theater systems to accommodate larger numbers of satellites and/or audio channels while maintaining lip-synchrony with corresponding displayed video content. As discussed above, one solution is to configure the primary device 202 to establish the dedicated wireless network for communicating with the satellites 204 over the communication links 203 in the 6 GHz band, which offers higher bandwidth for faster transmission of the audio data. However, this solution may only be acceptable in circumstances where all the satellite playback devices to be included in the home theater configuration are capable of connecting to a 6 GHz WI-FI network. Therefore, according to certain embodiments, the primary device 202 can be configured to adapt one or more configuration parameters of the dedicated wireless network, and optionally establish a second dedicated wireless network for communicating with one or more of the satellite playback devices, based on the capabilities of the satellite playback devices. In this manner, the primary device 202 can be configured to accommodate all available satellite playback devices, while also meeting requirements for home theater configurations with high data transmission needs (e.g., a high number of audio channels).

In the example of the home theater environment 200 illustrated in FIG. 2, the backhaul radio 212 is used to establish the backhaul connection 207 and the fronthaul radio 214 is used to establish the dedicated wireless network for communicating the audio channel samples 305 to the satellite playback devices 204 as discussed above. According to certain embodiments, a primary device can be configured to also use the backhaul radio to establish a second dedicated wireless network for communicating with one or more satellite playback devices when needed. This allows the wireless networks established by each of the backhaul radio and the fronthaul radio to have different parameters and therefore accommodate different communications capabilities or configurations associated with various satellite playback devices. The satellite playback devices can be divided into subsets and allocated between the two wireless networks based on their communications capabilities or configurations.

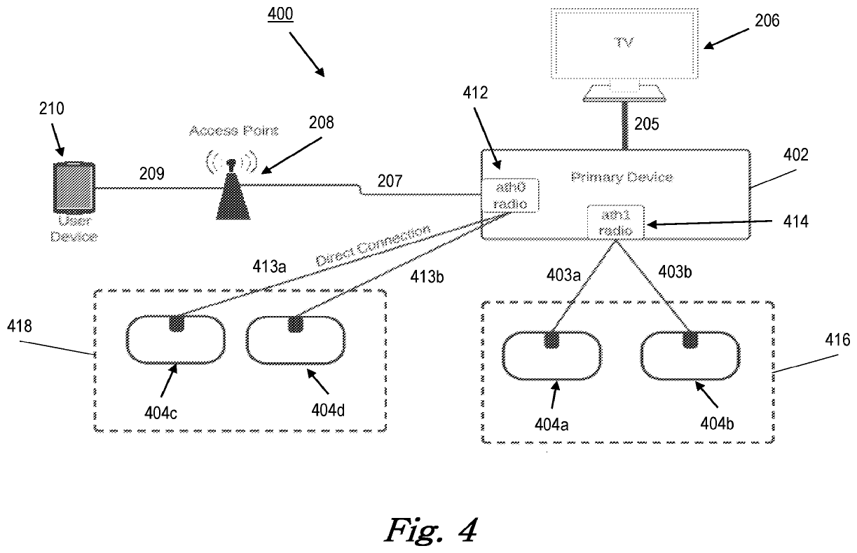

Referring to FIG. 4, there is illustrated an example of a home theater environment 400 with a primary device configured according to certain embodiments. In this example, a primary device 402 is capable of using both a backhaul radio 412 and a fronthaul radio 414 to establish direct connections to a plurality of satellite playback devices 404, as shown. The primary device 402 may use the backhaul radio 412 to establish the backhaul connection 207 to the AP 208 as discussed above. Based on one or more operating parameters or capabilities of the satellite playback devices 404, the primary device may allocate the satellite playback devices 404 into a first subset 416 and a second subset 418. The primary device 402 establishes a first dedicated wireless network using the fronthaul radio 414 to provide direct communication links 403a and 403b to the satellite playback devices 404a and 404b, respectively, in the first subset 416. The primary device 402 further establishes a second dedicated wireless network using the backhaul radio 412 to provide direct communication links 413a and 413b to the satellite playback devices 404c and 404d, respectively, in the second subset 418. Thus, the backhaul radio 412 acts as a “soft AP” for the second subset 418 of satellite playback devices 404. The second wireless network coexists with the backhaul connection 207, as discussed further below. In the example shown in FIG. 4, there are two satellite playback devices 404a, 404b in the first subset 416 and two satellite playback devices 404c, 404d in the second subset 418; however this example is illustrative only. In other examples, each subset 416, 418 may include one or more satellite playback devices 404 and the two subsets 416, 418 need not include the same number of satellite playback devices 404.

By using both the fronthaul radio 414 and the backhaul radio 412 for audio data transmission to the satellite playback devices 404, the primary device 402 can establish two dedicated wireless networks with different parameters (e.g., different frequency bands, different channel widths, etc.) based on the different capabilities and/or operating parameters of the different subsets 416, 418 of satellite playback devices 404. As discussed further below, the primary device 402 can divide the satellite playback devices 404 into the two subsets 416, 418, as needed, while coordinating with the AP 208/backhaul connection 207, to establish appropriate communications links 403, 413 for all the satellite playback devices 404 that allow efficient, low-latency communications to support a wide variety of home theater configurations.

According to certain examples, each of the first and second dedicated wireless networks may be established in a respective frequency range that does not overlap or interfere with the backhaul connection 207. In one example, the fronthaul radio 414 may be capable of dual-band operation; that is, capable of establishing a wireless network/connection in either of two different frequency bands, such as the 5 GHz band and the 6 GHz band, for example. The backhaul radio 412 may be capable of tri-band operation in certain examples, that is, capable of establishing a wireless network/connection in any of three different frequency bands, such as the 2.4 GHz band, the 5 GHz band, and the 6 GHz band, for example. The primary device 402 may be configured to take advantage of the multi-band capability of its backhaul and fronthaul radios 412, 414 to create the backhaul connection 207 and first and second dedicated wireless networks in different frequency bands and ranges as needed. For example, in certain instances, the frequency band of the backhaul connection 207 may be dictated by a set-up of the AP 208. Accordingly, the primary device 402 can be configured to establish the backhaul connection 207 in accordance with the requirements of the AP 208 and then establish the first and second wireless networks using remaining available frequency bands and ranges.

Various examples of configuring dedicated wireless networks for communicating with satellite playback devices 404, while coordinating with the backhaul connection 207, are described in commonly-owned International Patent Publication No. WO 2023/102511 titled “FLEXIBLE BACKHAUL TECHNIQUES FOR A WIRELESS HOME THEATER ENVIRONMENT” filed on Dec. 2, 2022 and published on Jun. 8, 2023, which is herein incorporated by reference in its entirety for all purposes.

As discussed above, the primary device 402 may flexibly configure the backhaul and fronthaul radios 412, 414 based on various parameters and needs of a given home theater configuration at any time. For example, in a scenario where the 6 GHz band is available for use by the fronthaul radio 414 to establish the first wireless network (i.e., the backhaul connection 207 is not required by the AP 208 to be in the 6 GHz band) and all the satellite playback devices 404 are capable of connecting to a 6 GHz wireless network, the primary device 402 may configure the fronthaul radio 414 to establish the first wireless network in the 6 GHz band and connect to all the satellite playback devices 404 via the first wireless network. In such an example, the backhaul radio 412 may establish the backhaul connection 207 as discussed above, but there may be no need to establish the second wireless network. In this scenario, the home theater configuration may resemble the example shown in FIG. 2, since the second wireless network on the backhaul radio is not needed. In another example, If the 6 GHz band is available for use by the fronthaul radio 414 to establish the first wireless network (i.e., the backhaul connection 207 is not required by the AP 208 to be in the 6 GHz band) and only some of the satellite playback devices have WI-FI 6 capability, the primary device 402 may implement a configuration as shown in FIG. 4. For example, the first subset 416 of satellite playback devices 404 may include those satellite playback devices 404a and 404b that support WI-FI 6, and the second subset 418 may include the remaining satellite playback devices 404 c and 404 d that have WI-FI 5 but not WI-FI 6 capability. In such an example, the primary device 402 may use the fronthaul radio 414 to establish the first wireless network in the 6 GHz band, and may configure the backhaul radio 412 to establish the backhaul connection 207 and the second wireless network for communicating with the satellite playback devices 404 c and 404 d in non-overlapping frequency ranges in the 5 GHz band. For example, as discussed above, the primary device 402 may split the 5 GHz band into multiple sub-bands, such as 5 GHz High sub-band and 5 GHz Low sub-band, each sub-band including a subset of the total number of available channels in the 5 GHz band. The primary device 402 may then configure the backhaul radio 412 to use one sub-band for the backhaul connection 207 and the other for the second wireless network. In certain examples, the sub-band selected for the backhaul connection 207 may be selected based on one or more operating parameters of the AP 208.

In another example, the first subset 416 of satellite playback devices may include those satellite playback devices 404a and 404b configured for wireless communications in accord with the IEEE 802.11n standard, for example, and the second subset 418 may include the remaining satellite playback devices 404c and 404d configured for wireless communications in accord with the IEEE 802.11ac standard, for example. While both these standards operate in the 5 GHz band, they have different protocols (e.g., different channel configurations etc.). Accordingly, using both the backhaul and fronthaul radios 412, 414 the primary device 402 can split the 5 GHz band into multiple sub-bands as discussed above, and establish two wireless networks, one configured in accord with each standard, in two of the sub-bands. In some instances, the backhaul radio 412 may be configured to establish the backhaul connection 207 in one sub-band and the second wireless network in a second sub-band, while the fronthaul radio 414 is configured to establish the first wireless network in a third sub-band. In other instances, the backhaul radio 412 may establish the backhaul connection 207 in the 2.4 GHz band and the fronthaul radio 414 may be configured to establish both the first and second wireless networks in two sub-bands of the 5 GHz band. As will be appreciated by those skilled in the art, given the benefit of this disclosure, numerous other configurations and examples may be implemented.

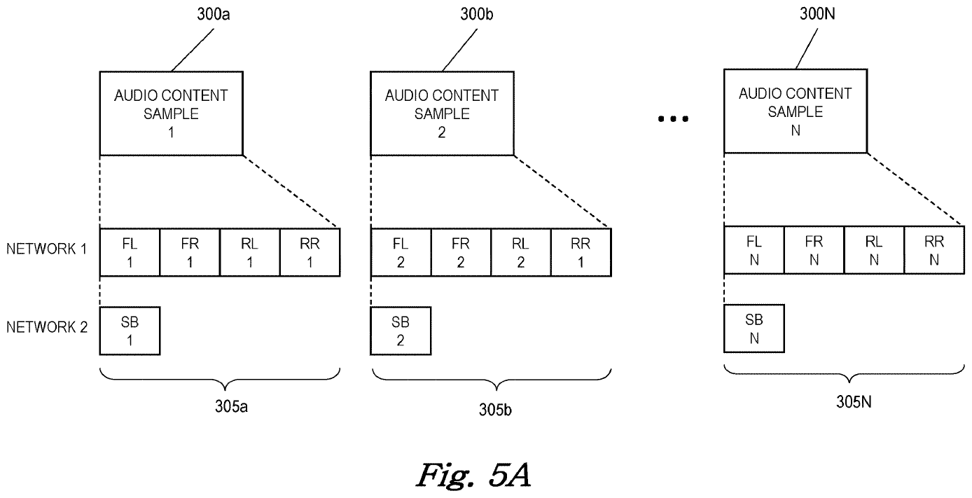

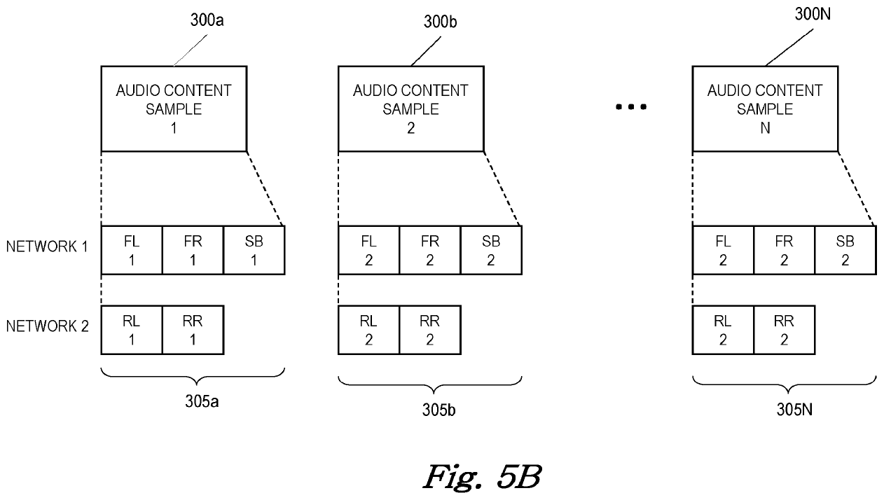

By allocating the plurality of satellite playback devices 404 among two concurrent dedicated wireless networks, the primary device 402 may be able to transmit more audio channels to more satellites more quickly. For example, consider a home theater configuration including left and right front satellites, left and right rear satellites, and a sub-woofer, as in the example discussed above with reference to FIG. 3A. The left and right front and rear satellites may be connected to the first wireless network established via the fronthaul radio 414, while the sub-woofer is connected to the second wireless network established via the backhaul radio 412, for example. In a configuration in which all the satellites communicate with the primary device via the fronthaul radio, each channel sample 305 (e.g., FL1, FR1, SB1, etc.) associated with a given audio content sample 300 is transmitted to the respective satellite playback device in a separate time slot (in a “Round Robin” manner), as discussed with reference to FIG. 3A. In contrast, referring to FIG. 5A, with the configuration example discussed above, because audio data can be transmitted to the sub-woofer over the second wireless network, independent of data transmission to the other satellites over the first wireless network, the sub-woofer channel sample (SB1) can be transmitted during the same time slot as any of the other channel samples 305 associated with each audio content sample 300, thus reducing the total time needed for transmission of all the channel samples 305 corresponding to each audio content sample 300. Similarly, if the two rear satellites are connected to the second wireless network, for example, while the two front satellites and the sub-woofer are connected to the first wireless network, the channel samples 305 for the two rear satellites (RL1, RR1) can be transmitted during the same time slots used for any of the channel samples 305 corresponding to the left and right front satellites or the sub-woofer (see FIG. 5B, for example). Those skilled in the art will appreciate that many variations of the above-discussed examples may be implemented in accord with the principles disclosed herein.

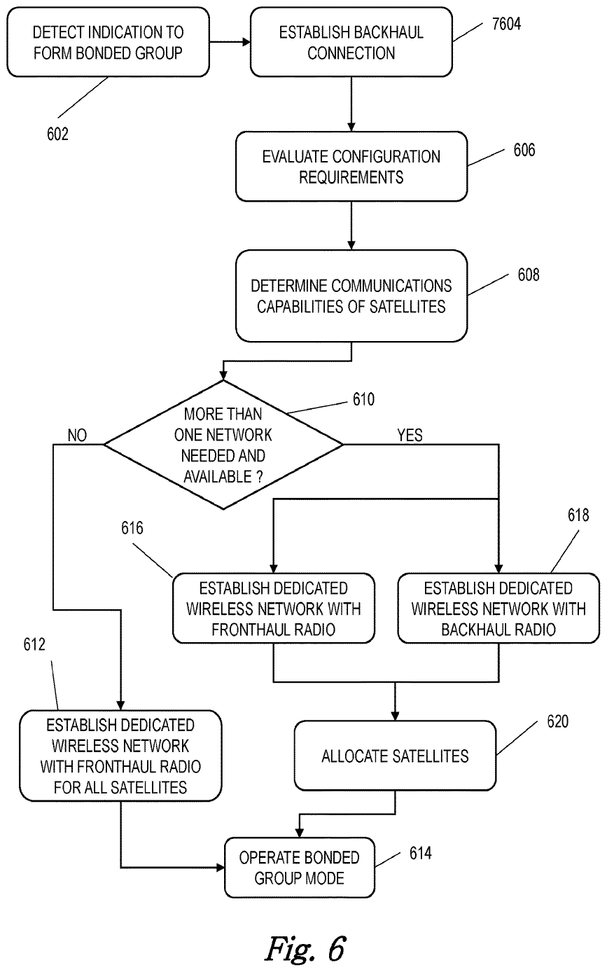

Thus, because the total transmission time for the all the channel samples 305 associated with each audio content sample 300 is reduced, the system may be able to accommodate more satellite playback devices and/or more audio channels while still keeping the total transmission time within the time window required to maintain lip synchrony with corresponding video content. Accordingly, the system can support more complex home theater arrangements, as well as supporting the ability of certain satellite playback devices to render more than one audio channel (e.g., having two, four, or some other number of channel samples 305 associated with each audio content sample 300, rather than only a single channel sample per audio content sample as in the examples shown in FIGS. 6A and 6B). For example, as discussed above, certain satellite playback devices may be assigned to render both a right-rear channel and a height channel. In such an instance, a transmission to that satellite playback device for each audio content sample 300 may comprise a right-rear channel sample and a height channel sample for the satellite playback device to render.

As discussed above, in certain examples, the satellite playback devices 404 may be divided into the two subsets 416, 418 based on differing capabilities, such as whether or not each satellite is capable of supporting WI-FI 6. However, in other examples, the satellite playback devices may be divided into the two subsets 416, 418 simply to obtain the data transmission time advantages discussed above, even if all the satellite playback devices 404 have the same capabilities. For example, where a user may wish to use several satellite playback devices 404 that are all capable of rendering multiple channels of audio (e.g., four channels each), the number of channel samples 305 that need to be transmitted for each audio content sample 300 may be relatively high. Accordingly, the primary device 402 may allocate some of the satellite playback devices 404 to the backhaul radio 412 to reduce the total transmission time required for all the channel samples 305, thereby making it easier to meet the latency requirements needed to maintain lip-synchrony with corresponding video content. In certain examples, particularly where the fronthaul radio 414 may use the 6 GHz band for the first wireless network and the backhaul radio 412 uses the 5 GHz band, one or more satellite payback devices 404 with lower channel requirements (e.g., the sub-woofer, which usually only renders a single channel of audio) may be allocated to the second subset 418 on the backhaul radio 412.

Referring to FIG. 6, there is illustrated a flow diagram of one example of a method of configuring a bonded group of playback devices, such as a home theater group, according to certain examples.

At step 602, the primary device 402 detects an indication to form a bonded group including a plurality of satellite playback devices 404. In certain examples, the bonded group may be a home theater arrangement, as discussed above. However, in other examples, the bonded group may include a grouping of multiple satellite playback devices in which the different playback devices within the group (e.g., the satellites and the primary device) render different audio channels rather than rendering the same channels, that may not necessarily be a home theater arrangement. One such example includes a Dolby Atmos Music bonded group, which may include four or more playback devices rendering different channels of audio content.

At step 604, the primary device 402 may establish the backhaul connection 207 to the AP 208 using the backhaul radio 412 as discussed above. In certain examples, the frequency band and/or range selected for the backhaul connection 207 may depend at least in part on the configuration of the AP 208.

At step 606, the configuration requirements for the desired bonded group may be determined. These requirements may include, for example, the number of satellite playback devices 404 to be included in the bonded group and the number of audio channels to be rendered by each satellite playback device 404. This information may be provided, for example, via a controller device 130 (FIG. 1H) or other user interface.

At step 608, the primary device 402 may determine the communications capabilities of the satellite playback devices 404 to be included in the bonded group. For example, whether one or more of the satellite playback devices 404 are capable of connecting to a 6 GHz wireless network.

It is to be appreciated that although steps 602, 606, and 608 are illustrated as separate steps in FIG. 6, these actions may all performed as part of an overall initial set-up/configuration process and not necessarily as individual steps. Further, steps 604, 606, and 608 need not be performed in the sequence shown, but may be performed in another order or simultaneously.

Based on the information gathered in steps 602-608, the primary device 402 may determine whether or not a second wireless network should be established using the backhaul radio 412 (step 610). For example, as discussed above, if all the satellite playback devices 404 are capable of connecting to a 6 GHz wireless network, the 6 GHz band is available for use by the fronthaul radio 414, and the total number of audio channels to be rendered can be supported within the latency requirements for the bonded group arrangement (e.g., within the time window to maintain lip-synchrony in a home theater arrangement), then allocating one or more satellites to the backhaul radio may not be necessary. Accordingly, in such examples, the primary device 402 may establish the first wireless network using the fronthaul radio 414 and connect to all the satellite playback devices 404 via the first wireless network (step 612). In another example, it may be preferable to allocate one or more satellite playback devices 404 to the backhaul radio 412, but that option may not be available to the primary device 402. For example, if the AP 208 requires that the backhaul connection 207 be a 2.4 GHz connection, the 2.4 GHz band may not support the addition of the second wireless network. Accordingly, in step 612, the primary device 402 may establish the first wireless network based on the least-capable satellite playback device 404 such that all satellites can connect via the fronthaul radio 414. Those skilled in the art will appreciate, given the benefit of this disclosure, that numerous other scenarios are possible; however, in all instances, where the allocation of one or more satellite playback devices 404 to the backhaul radio 412 is either not necessary or not feasible, in step 612 the primary device 402 establishes the first wireless network using the fronthaul radio 414 and connects all the satellite playback devices 404 to the first wireless network (similar to the arrangement shown in FIG. 2). In such examples, the parameters (e.g., frequency range, channel configuration, etc.) of the first wireless network may be selected such that all the satellite playback devices are capable of connecting the first wireless network and such that the first wireless network does not overlap or interfere with the backhaul connection 207.

Once the primary device 402 has established direct connections to all the satellite playback devices 404, the system may operate in the bonded group mode (step 614).

In other examples, such as where the satellite playback devices have differing capabilities or where due to the number of audio channels to be rendered, meeting the timing requirements for maintaining lip synchrony would be challenging, and a frequency range is available to primary device in which to establish a second wireless network using the backhaul radio 412, the primary device 402 can configure both the fronthaul radio 414 and the backhaul radio 412 to establish dedicated wireless networks for subsets of the plurality of satellite playback devices 404, as discussed above. In such examples, the method may proceed from step 610 to steps 616 and 618 as shown.

In step 616, the primary device 402 may establish the first dedicated wireless network using the fronthaul radio 414, as discussed above. In certain examples, the frequency range for the first dedicated wireless network may be selected from available ranges (i.e., supported by the fronthaul radio 414 and not occupied by the backhaul connection 207) based on the communications capabilities of one or more of the satellite playback devices 404 that are to be connected to the first wireless network. In some examples, the first wireless network is established in the 6 GHz band.

In step 618, the primary device 402 may establish the second dedicated wireless network using the backhaul radio 412, as discussed above. In certain examples, the frequency range for the second dedicated wireless network may be selected to coexist with the backhaul connection 207. For example, as discussed above, the primary device 402 may split the 5 GHZ band into multiple non-overlapping sub-bands, such that one sub-band can be used for the backhaul connection and another for the second wireless network.

In step 620, the primary device 402 may allocate the plurality of satellite playback devices 404 into the first subset 416 and the second subset 418, as discussed above. The primary device 402 may establish direct connections to each one or more satellite playback devices 404 in the first subset 416 over the first wireless network, and establish direct connections to each one or more satellite playback devices 404 in the second subset 418 over the second wireless network. Although steps 616, 618, and 620 are illustrated as separate steps in FIG. 6, those skilled in the art will appreciate that the steps may be performed together or partially together and not necessarily in sequence.

Once the primary device 402 has established direct connections to all the satellite playback devices 404, the system may operate in the bonded group mode (step 614).

The primary device 402 may perform instances of the method shown in FIG. 6, or variations thereof, whenever a bonded group is to be formed or modified. For example, if a new satellite playback device 404 is to be added to the bonded group, the primary device 402 may evaluate the capabilities of the new satellite playback device and impact of its addition on the group requirements and, if needed, (i) add a second wireless network using the backhaul radio 412 if one is not already established; (ii) add the new satellite playback device to either the first subset 416 or the second subset 418; and/or (iii) modify parameters of either the first wireless network or the second wireless network to accommodate the new satellite playback device. Similarly, if the network conditions change, or one or more parameters of the AP 208 change, for example, the primary device 402 may reconfigure either or both of the first and second wireless networks to accommodate such changes. Thus, according to aspects and embodiments disclosed herein, the primary device 402 can flexibly establish and/or modify one or more dedicated wireless networks for communication with satellite playback devices 404, as needed, to accommodate a wide variety of different bonded group arrangements and conditions.

As discussed above, in certain circumstances, it may not be feasible to establish the second wireless network using the backhaul radio 412. In other examples, even though one or more satellite playback devices 404 can be allocated to the second wireless network, conditions on the first wireless network may be such that the network cannot support the full number of audio channels that one or more of the satellite playback devices in the first subset 416 are capable of rendering. Similarly, in certain circumstances, if one or more satellite playback devices that are capable of rendering multiple audio channels are allocated to the second subset 418, network conditions on the second wireless network may be such that the network cannot support the full number of audio channels that one or more of the satellite playback devices in the second subset 418 are capable of rendering. In such scenarios, the size of the data to be transmitted to those satellite playback devices can be reduced by compressing and/or truncating the audio. For example, a Pulse-Code-Modulation (PCM) audio stream with 4 channels may be compressed down to a PCM audio stream that only requires the bandwidth of between 1 and 2 channels (e.g., 1.8 channels). In another instance, only a subset of the channels (e.g., 2 out of 4 channels) or subsets of particular channels (e.g., only high-frequency content of one channel, only low-frequency content of another channel) may be transmitted to satellite playback device. In some instances, it may be known that certain channels, or portions thereof, contain little audio content and therefore excluding those channels (or portions) may not significantly degrade the overall acoustic output rendered by the satellite playback device or bonded group as a whole. In other examples, the satellite playback device may be configured to up-mix the received PCM audio to recreate the complete channel set (or approximation thereof). Examples of compressing and/or truncating audio transmissions to satellite playback devices are described in commonly-owned U.S. Provisional Patent Application No. 63/362,365 titled “MULTICHANNEL COMPRESSED AUDIO TRANSMISSION TO SATELLITE PLAYBACK DEVICES” and filed on Apr. 1, 2022, which is herein incorporated by reference in its entirety for all purposes.

Thus, in situations where it may be needed or preferred, the audio data transmitted to any one or more of the satellite playback devices 404 may be compressed or truncated. In other examples, the audio data may be transmitted without compression and/or truncation.

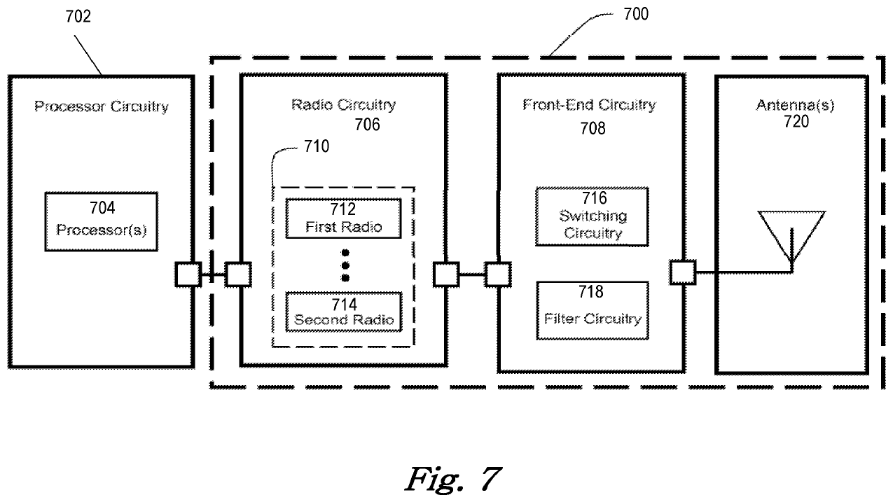

Referring to FIG. 7, there is illustrated an example of a logical diagram of a wireless communication interface 700 (such as network interface 112d (FIG. 1C) discussed above) that may be integrated into any of the devices described herein, including the primary device 402. As shown, the wireless communication interface 700 may be communicatively coupled to processor circuitry 702 that may comprise one or more processors 704 (such as processor 112a (FIG. 1C) discussed above, for example). The wireless communication interface 700 comprises radio circuitry 706, front-end circuitry 708, and one or more antennas 720. The radio circuitry comprises a plurality of radios 710, including at least a first radio 712 (e.g., the backhaul radio 412) and a second radio 714 (e.g., the fronthaul radio 414). The front end-circuitry 406 includes switching circuitry 716 and filter circuitry 718.

The processor circuitry 702 may comprise one or more processors 704 that execute instructions stored in memory (e.g., memory 112b; FIG. 1C) to facilitate performance of any of a variety of operations including, for instance, those operations described herein. The memory may be integrated into the processor circuitry 702 or separate from the processor circuitry 702. The processor circuitry 702 may be implemented using one or more integrated circuits (ICs) that may be packaged separately, together in any combination, or left unpackaged. In some examples, the processor circuitry 702 may be implemented using a System-On-a-Chip (SoC) into which the processor(s) 704 may be integrated. The processor 704 can correspond to or include the capabilities of the processors 112a described above.

The radio circuitry 706 may be coupled to the processor circuitry 702 and comprise a plurality of radios 710 to facilitate wireless communication. As noted above, the plurality of radios 710 may include the first radio 712 and the second radio 714; however, it should be appreciated that the plurality of radios 710 may include any number of radios (e.g., three radios, four radios, etc.) and is not limited to two radios. In some instances, the first radio 712 may be employed to facilitate communication over a backhaul connection (e.g., connection 207 in FIG. 2) as well as optional communication with one or more satellite playback devices (e.g., connections 413 in FIG. 4) and the second radio 714 may be employed to facilitate communication with one or more satellite playback devices (e.g., connections 403 in FIG. 4). The radio circuitry 706 may be implemented using one or more integrated circuits (ICs) that may be packaged separately, together in any combination, or left unpackaged. In some instances, the first radio 712 and the second radio 714 may be integrated into separate ICs. In other instances, the first radio 712 and the second radio 714 may be integrated into a single IC.

The front-end circuitry 708 may be coupled between the radio circuitry 706 and the antenna(s) 720. The front-end circuitry 708 may comprise switching circuitry 716 and filter circuitry 718. The switching circuitry 708 may comprise one or more switches to control which of the antenna(s) 720 are coupled to which ports of the radio circuitry 706 based on received control signals (e.g., from the radio circuitry 706, the processor circuitry 702, or any component thereof). Examples of switches that may be incorporated into the switching circuitry 716 include: Single Pole Single Throw (SP1T) switches, Single Pole Double Throw (SP2T) switches, Single Pole Triple Throw (SP3T) switches, Double Pole Single Throw (DP1T) switches, Double Pole Double Throw (DP2T) switches, and/or Double Pole Triple Throw (DP3T) switches. The filter circuitry 718 may comprise one or more filters to filter signals going to (or being received from) the antenna(s) 720. Example filters that may be incorporated into the filter circuitry 718 include: bandpass filters, lowpass filters, highpass filters, all-pass filters, and diplexers. The front-end circuitry 708 may be implemented using one or more integrated circuits (ICs) that may be packaged separately, together in any combination, or left unpackaged.

Various examples of switching circuitry 716 and filter circuitry 718 and configurations for establishing wireless networks in different frequency ranges are disclosed in International Publication No. WO 2023/102511 referenced above.

The antenna(s) 720 may be configured to radiate and/or detect electromagnetic waves. The antenna(s) 720 may have any of a variety of constructions. For example, one or more of the antenna(s) 720 may be multi-band antennas (e.g., dual-band antennas, tri-band antennas, etc.) configured to operate on several bands (e.g., two or more of: the 2.4 GHz band, the 5 GHz band, and the 6 GHz band). Additionally (or alternatively), the antenna(s) 720 may comprise one or more single-band antennas configured to operate on a single band (e.g., the 2.4 GHz band (or any portion thereof), the 5 GHz band (or any portion thereof), the 6 GHz band (or any portion thereof), etc.).

It should be appreciated that one or any combination of the ICs described above with respect to processor circuitry 702, radio circuitry 706, and/or front-end circuitry 708 may be mounted to (or otherwise attached) to one or more substrates, such as a circuit board. In some instances, all of the ICs in the processor circuitry 702, radio circuitry 706, and/or front-end circuitry 708 may be mounted to a single circuit board. In other instances, the ICs in the processor circuitry 702, radio circuitry 706, and/or front-end circuitry 708 may be distributed across multiple circuit boards that may be communicatively coupled to each other (e.g., using one or more cables).

Thus, aspects and embodiments provide methods, systems, and devices that allow for the flexible and dynamic configuring and reconfiguring of the networks used to communicate audio data from a primary device to one or more satellite playback devices in order to provide a low-latency communication scheme that can adapt to different environments and operating conditions. By using multiple radios for audio data transmission to the satellite playback devices and intelligently allocating the satellites among the different radios, efficient low-latency communications can be achieved that support enhanced system features (such as home theater configurations with more dedicated satellites and/or rendering of multiple audio channels by one or more individual satellite playback devices) while still offering backwards compatibility with satellites that may not support newer communications standards or protocols. Embodiments of the systems, methods, and devices disclosed herein may allow a user to enjoy premium features associated with newer satellite and/or primary devices and obtain the benefits of newer communications protocols (such as WI-FI 6), while still being able to use their older or less capable satellites.

As discussed above, in certain circumstances, a user may wish to transition a playback session from their home theater group, or another bonded group, to a portable playback device, such as headphones or another carryable playback device. To achieve the transition, the primary device may enter a mode referred to herein as a “home theater swap mode,” or simply “swap mode.” In the swap mode, the primary device 402 functions as the source device for the audio, and the portable playback device becomes the target playback device to receive and play back the audio from the primary device 402. When performing a swap action with a portable playback device, the portable playback device effectively becomes a satellite of the primary device 402. In such instances, the primary device 402 may establish communications with, and transmit the audio data to, the portable playback device over the first dedicated wireless network using the fronthaul radio 414. In many instances, the portable playback device may have different capabilities than the one or more satellite playback devices in the first subset 416. As a result, the primary playback device 402 may need to reconfigure one or more parameters (e.g., frequency range, channel width, etc.) of the first wireless network to accommodate the portable playback device. In addition, since after the swap occurs, the satellite playback device(s) in the first subset will no longer being playing back the audio content, the primary device 402 may cause these satellite playback devices to be disconnected from the first wireless network. In some examples, the primary device 402 may “park” the first subset 416 of satellite playback device(s) on the second wireless network, which may also require modifications to be made to one or more parameters of the second wireless network. Any modifications to the first and/or second wireless networks may be made without disrupting or interfering with the backhaul connection 207. Accordingly, as discussed in more detail below, the primary device 402 may perform a series of actions to seamlessly transition the playback session to the portable playback device, reconfiguring the first and/or second wireless networks as may be needed to achieve the transition. Further, the primary device 402 may perform at least some of these action “in reverse” to transition a playback session from the portable playback device back to the home theater bonded group, as also discussed further below.

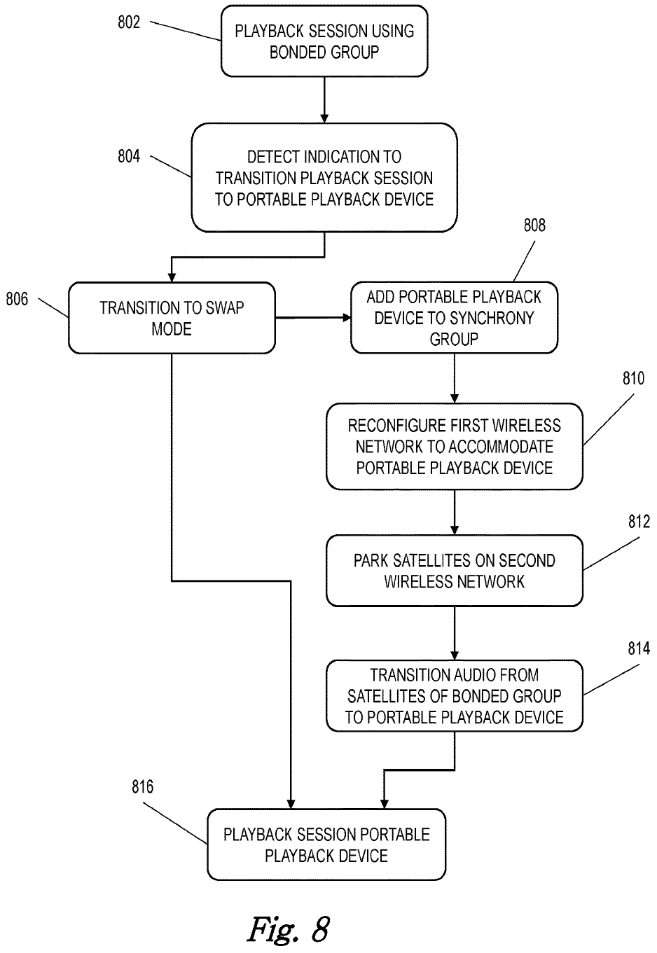

FIG. 8 illustrates a flow diagram of one example of a method of performing a playback session swap from a bonded group of satellite playback devices (e.g., a home theater bonded group) to a portable playback device, in accordance with aspects of this disclosure. Aspects and examples of the method are discussed below with references to FIGS. 8, 9, 11A, and 11B. In addition, further examples of swap techniques are disclosed in U.S. Pat. No. 11,356,777, which is hereby incorporated herein by reference in its entirety for all purposes.

Referring to FIG. 8, at block 802, the primary device 402 coordinates a home theater (HT) playback session with the one or more satellite playback devices 404, as discussed above.

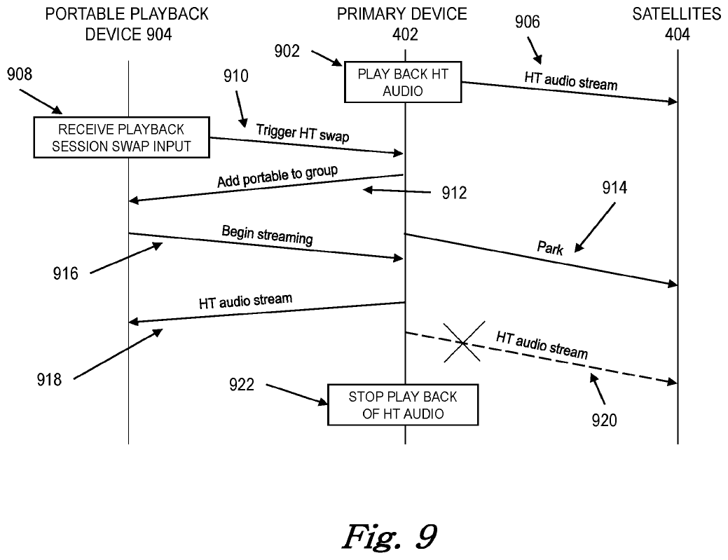

FIG. 9 is a message flow diagram showing an example of communications and data transmission between the primary device 402, a portable device 904, and the one or more satellite playback devices 404 in the home theater bonded group as discussed above. In the illustrated example, the primary device 402 is a playback device, such as a soundbar-type playback device. Therefore, during a home theater playback session (FIG. 8, block 802) and before entering the swap mode, the primary device 402 may play back one or more channels of the home theater (HT) audio content, as discussed above, and as indicated at block 902 in FIG. 9. In addition, as the sourcing device of the bonded group that includes the satellites 404, in the home theater mode, the primary device 402 distributes audio to the satellites 404 (indicated at 906 in FIG. 9) according to their roles in the bonded group, as discussed above.

At block 804 in FIG. 8, the primary device 402 detects an indication that the playback session is to be transitioned to the portable playback device 904.

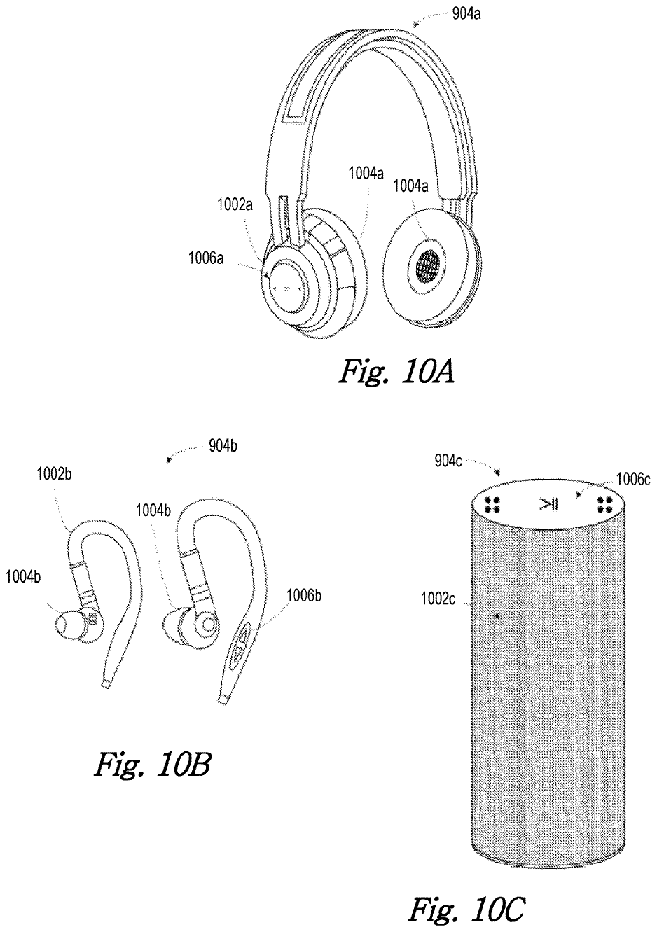

In the example illustrated in FIG. 9 and discussed below, the portable playback device initiates the swap mode. Accordingly, referring to FIG. 9, at block 908, the portable playback device 904 receives a playback session swap input. The swap input may be a direct user input received at the portable playback device 904, or may be an input received from a controller device 130, for example. In other examples, the primary device 402 may receive the swap input and initiate the swap mode. In examples in which the swap input is a direct user input received at the portable playback device 904, the swap input may be a touch-and-hold input via a user interface 1006 (FIGS. 10A-C) of the portable playback device 904.

FIGS. 10A-C illustrate various examples of the portable playback device 904. FIG. 10A is a front isometric view of an example of a portable playback device 904a configured in accordance with aspects of the disclosed technology. As shown in FIGS. 10A and 10B, the portable playback devices 904a, 904b may be implemented as headphones to facilitate more private playback as compared with the out loud playback associated with the satellite playback device(s) 404, for example. In the example shown in FIG. 10A, the portable playback device 904a includes a housing 1002a to support a pair of transducers 1004a on or around a user's head over the user's ears. The portable playback device 904a also includes a user interface 1006a with a touch-sensitive region to facilitate playback controls such as transport and/or volume controls. The touch-sensitive region of the user interface 1006 may support gesture controls. For instance, a swipe forward or backward across the touch-sensitive region may skip forward or backwards, respectively. Other gestures include a touch-and-hold, as well as a touch-and-continued hold, which may correspond to swap functions, as described further below. In some implementations, the user interface 1006a may include respective touch-sensitive regions on the exterior of each earcup.

FIG. 10B is a front isometric view of an example of the portable playback device 904b, implemented as earbud-type headphones. As shown, the portable playback device 904b includes a housing 1002b to support a pair of transducers 1004b within a user's ears. The portable playback device 904b also includes a user interface 1006b with a touch-sensitive region to facilitate playback controls such as transport, volume, and/or swap controls. The portable playback device 904b can be in the form of wired, wireless, or true wireless earbuds.

FIG. 10C is a front isometric view of an example of a portable playback device 904c. In certain examples, as compared with the headphones of FIGS. 10A and 10B, the portable playback device 904c may include one or more larger transducers (not shown) to facilitate out loud audio content playback. A speaker grill 1002c covers the transducers. Relative to certain ones of the playback device(s) 110 discussed above, the portable playback device 904c may include less powerful amplifier(s) and/or smaller transducer(s) to balance battery life, sound output capability, and form factor (i.e., size, shape, and weight) of the portable playback device 904c. The portable playback device 904c includes a user interface 1006c with a touch-sensitive region to facilitate playback controls such as transport, volume, and/or swap controls.

Referring again to FIG. 9, after receiving the swap input at 908, in some examples, the portable playback device 904 may identify the primary device 402 as the source for the swap (e.g., based on determining that the primary device 402 is the physically nearest playback device using an audio-based identification technique). In such examples, at 910, the portable playback device 904 may send data to the primary device 402 representing instructions to transition to the swap mode, which are received by the primary device 402 (block 804 in FIG. 8). In other examples, after receiving the swap input at block 908, the portable playback device may broadcast a swap trigger signal, rather than specifically identifying the primary device 402 as the source for the swap. The primary device 402 may detect the swap trigger signal (block 804), identify the portable playback device 904 as the target device for the swap, and initiate the transition to swap mode based on detection of the swap trigger signal. In certain examples, the portable playback device 904 and the primary device 402 may send and receive the data representing the swap trigger signal/instructions via respective 802.11-compatible network interfaces.

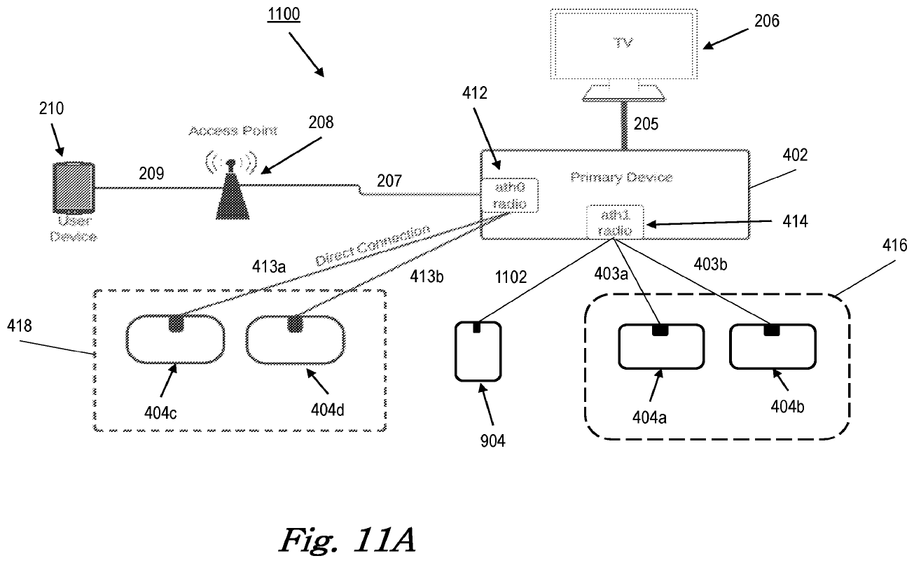

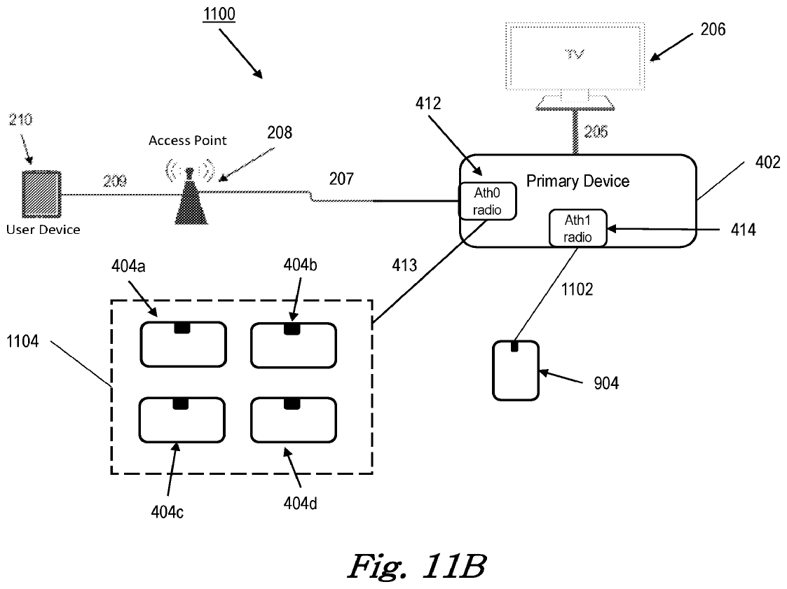

Based on receiving the data representing the instructions to enter the swap mode, the primary device 402 transitions from the home theater mode to the swap mode (806 in FIG. 8). In certain examples, this transition 806 may include various steps. For example, at 912 in FIG. 9 (block 808 in FIG. 8), the primary device 402 may add the portable playback device 904 to a synchrony group with the one or more satellite playback devices 404. In particular, referring to FIG. 11A, the primary device 402 may establish a direct connection 1102 with the portable playback device 904 using the fronthaul radio 414. As discussed above with reference to FIG. 4, in certain examples, while operating in the home theater mode, the primary device 402 establishes the first dedicated wireless network using the fronthaul radio 414 to provide direct communication links 403a and 403b to the satellite playback devices 404a and 404b, respectively, in the first subset 416 of satellite playback devices 404, and establishes the second dedicated wireless network using the backhaul radio 412 to provide direct communication links 413a and 413b to the satellite playback devices 404c and 404d, respectively, in the second subset 418. In certain examples, the portable playback device 904 may have communication capabilities that are the same as, or at least sufficiently similar to, the first subset 416 of satellite playback devices 404 that the portable playback device 904 can connect to the first wireless network in order to establish the communication link 1102. For example, if the fronthaul radio 414 is configured to provide the first wireless network as a 6 GHz network (as discussed above), and the portable playback device 904 supports WI-FI 6, the portable playback device 904 may be connected to the first wireless network along with the first subset 416 of satellite playback devices. However, in other examples, a combination of the parameters of the first wireless network and the communications capabilities of the portable playback device 904 may be such that the portable playback device 904 cannot connect to the existing first wireless network.

Accordingly, as indicated at block 810 in FIG. 8, the primary device 402 may control the fronthaul radio 414 to reconfigure one or more parameters of the first wireless network to accommodate the portable playback device 904. In certain examples, prior to reconfiguring the first wireless network, the primary device may move the first subset 416 of satellite playback devices from the first wireless network onto the second wireless network that has been established using the backhaul radio 412. Thus, while in swap mode, the primary device 402 may “park” the satellite playback devices 404 on the second wireless network (indicated at 812 in FIGS. 8 and 914 in FIG. 9) because the satellite playback devices 404 will not be playing back audio. Parking the satellite playback devices 404 on the second wireless network allows the satellites to remain contactable (e.g., to eventually re-form the bonded group when transitioning back to the home theater mode) and to receive updates on the state of the media playback system (e.g., state variable events), for example. FIG. 11B illustrates an example of the home theater environment 1100 in the swap mode. In this example, the portable playback device 904 is connected to the fronthaul radio 414 (via the first wireless network 1102) and all the satellite devices 404 (formerly in the two subsets 416, 418) are in one group 1104 connected to the backhaul radio 412 via the second wireless network 413 (i.e., “parked” on the second wireless network).

As discussed above, the primary device 402 may reconfigure the first wireless network in such a manner so as to coordinate with the second wireless network (that may now support all the satellite playback devices 404, as shown in FIG. 11B) and the backhaul connection 207. In reconfiguring the first wireless network 1102, the primary device 402 may take into account the communication capabilities of the portable playback device 904 and the requirements for the second wireless network 413 and the backhaul connection 207. For example, if the portable playback device 904 supports WI-FI 6, the primary device 402 may configure the fronthaul radio 414 to establish the first wireless network 1102 in the 6 GHZ band. The second wireless network 413 and the backhaul connection 207 may be in different frequency ranges in the 5 GHz band, for example, as discussed above. If the portable playback device 904 is not capable of connecting to a 6 GHz wireless network, the primary device may configure the fronthaul radio 414 and the backhaul radio 412 to split the 5 GHz band into three different, non-overlapping ranges, for example, so as to accommodate the first wireless network 1102, the second wireless network 413, and the backhaul connection 207. In some instances, in the home theater mode where the satellite devices 404 are receiving audio data, it may not be possible to configure the second wireless network in the 2.4 GHz band due to bandwidth constraints. However, in examples in the which the backhaul connection 207 may be in the 2.4 GHz band, in the swap mode, because the satellite playback devices are not playing back audio, the primary device 402 may establish the second wireless network in a range of the 2.4 GHz band that does not overlap with the backhaul connection 207. This may allow the fronthaul radio 414 to establish the first wireless network 1102 for the portable playback device 904 in the 5 GHz band. As will be appreciated by those skilled in the art, various other configurations and examples may be implemented, some of which are disclosed in International Publication No. WO 2023/102511 and U.S. Pat. No. 11,356,777 referenced above. In each example, however, the primary device 402 configures the fronthaul radio 414 and the backhaul radio 412 so as to accommodate any requirements for the backhaul connection 207 set by the AP 208 and to provide the first and second wireless networks 1102, 413 that are appropriately configured for the portable playback device 904 and the satellite playback devices 404, respectively, and which do not interfere with one another or with the backhaul connection 207.

Referring again to FIG. 9, at 912, the primary device 402 may send to the portable playback device 904, data representing a service set identifier (SSID) of the first wireless network and credentials for the first wireless network that allow the portable playback device 904 to connect to the first wireless network. After the portable playback device 904 connects to the first wireless network 1102 established by the fronthaul radio 414, the primary device 402 forms a bonded group that includes the primary device 402 and the portable playback device 904. Thus, in the swap mode, the portable playback device 904 effectively becomes a satellite of the primary device 402.

After connecting to the first wireless network 1102, the portable playback device 904 may send a message to the primary device 402 to start transmitting the HT audio stream to the portable playback device (indicated at 916 in FIG. 9).

At block 814 (FIG. 8), the primary device 402 may transition the HT audio stream from the satellite playback devices 404 to the portable playback device 904. Thus, referring to FIG. 9, at 918, the primary device 402 streams the HT audio stream to the portable playback device 904 for playback. At the same time, or shortly thereafter, at 920, the primary device 402 stops streaming the HT audio stream to the satellite playback devices 404. This may be performed as part of or in connection with parking the satellite playback devices 404 on the second wireless network as discussed above. Similarly, in connection with the portable playback device 904 receiving the HT audio stream and playing back the audio, the primary device 402 mutes to complete the swap (block 922 in FIG. 9). When muted, the primary device 402 may continue to process audio data for playback in lip-synchrony with video content displayed on the display device 206. Thus, at block 816 in FIG. 8, the playback session continues seamlessly on the portable playback device 904.

While in the swap mode, the primary device 402 may detect an event representing a trigger to transition from operating in the swap mode to operating in the home theater mode. Such an event may include receiving, from the portable playback device 904, data representing instructions to transition to the home theater mode (e.g., to end the swap mode), which the portable playback device 904 may send after receiving a playback session swap input while in the swap mode. As another example, the primary device 402 may detect that the portable playback device 904 has disconnected from the first wireless network 1102 (and as such is no longer operating as a satellite) or been paused for a predetermined amount of time. In other examples, the primary device may receive data representing instructions to transition to the home theater mode from a controller device 130, or may directly receive instructions from a user (e.g., via a voice command). Based on detecting such an event, the primary device 402 may transition to the home theater mode. In transitioning to the home theater mode, the primary device may cause the portable playback device 904 to be disconnected from the first wireless network 1102 (if it is still connected), and reestablish the home theater configuration as discussed above with reference to FIGS. 4 and 6, for example.

Thus, aspects and embodiments provide techniques for seamlessly accommodating a portable playback device as a temporary satellite in a bonded group arrangement, such as a home theater configuration, and transitioning a playback session to and from the portable playback device. Techniques disclosed herein allow for the flexible and dynamic configuring and reconfiguring of the networks used to communicate audio data from a primary device to the satellite playback devices, including the portable playback device, to adjust to different communication capabilities of different satellites, and provide seamless transitions while maintaining low-latency communications to ensure lip-synchrony with corresponding video content.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for the implementation of the functions and methods.

The description above discloses, among other things, various example systems, methods, apparatus, and articles of manufacture including, among other components, firmware and/or software executed on hardware. Such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment disclosed herein. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well-known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### V. EXAMPLES

(Example 1) A playback device comprising: radio circuitry including a first radio and a second radio; at least one antenna coupled to the radio circuitry; at least one processor; at least one non-transitory computer-readable medium; and program instructions stored on the non-transitory computer-readable medium that are executable by the at least one processor to control the playback device to operate in a bonded group comprising the playback device and a plurality of satellite playback devices, to operate in the bonded group comprising to connect, using the first radio, to a first wireless network; establish, using the second radio, a second wireless network; receive an audio stream including multi-channel audio content; identify, based on one or more capabilities of the plurality of satellite playback devices, a first subset of the plurality of satellite playback devices and a second subset of the plurality of satellite playback devices; communicate at least one first audio channel of the multi-channel audio content to the first subset of satellite playback devices over the first wireless network; communicate at least one second audio channel of the multi-channel audio content to the second subset of satellite playback devices over the second wireless network; and render at least one third audio channel of the multi-channel audio content in synchrony with rendering of the at least one first audio channel by the first subset of satellite playback devices and rendering of the at least one second audio channel by the second subset of satellite playback devices.

(Example 2) The playback device of Example 1, wherein the at least one non-transitory computer-readable medium further comprises program instructions that are executable by the at least one processor to control the playback device to detect an indication to form the bonded group.

(Example 3) The playback device of one of Examples 1 and 2, wherein to establish the second wireless network comprises to: identify one or more parameters for the second wireless network based on at least one of one or more parameters for the first wireless network or the one or more capabilities of the plurality of satellite playback devices; and establish, using the second radio, the second wireless network in accordance with the one or more parameters identified for the second wireless network.

(Example 4) The playback device of Example 3, wherein the one or more parameters of the first wireless network include a frequency band of the first wireless network.

(Example 5) The playback device of any one of Examples 1-3, wherein the one or more capabilities of the plurality of satellite playback devices include one or more communication frequency bands, and wherein the program instructions that are executable by the at least one processor such that the playback device is configured to identify the first and second subsets of the plurality of satellite playback devices include program instructions that are executable by the at least one processor such that the playback device is configured to: identify the second subset of the plurality of satellite playback devices as being capable of communicating over a 6 GHz frequency band.

(Example 6) The playback device of Example 5, wherein to establish the second wireless network comprises to: establish the second wireless network in the 6 GHz frequency band.

(Example 7) The playback device of Example 6, wherein the first wireless network is in one of a 2.4 GHz frequency band and a 5 GHz frequency band.

(Example 8) The playback device of Example 7, wherein the at least one antenna is a multi-band antenna configured to operate in two or more frequency bands.

(Example 9) The playback device of any one of Examples 1-8, wherein the first wireless network includes a WI-FI Access Point (AP).

(Example 10) The playback device of any one of Examples 1-9, wherein the playback device is a soundbar.

(Example 11) The playback device of Example 10, wherein the multi-channel audio content is synchronized to video content, and wherein an audio delay between the multi-channel audio content received by the playback device and rendering of the at least one first audio channel by the first subset of satellite playback devices and rendering of the at least one second audio channel by the second subset of satellite playback devices is less than 40 ms.

(Example 12) The playback device of any one of Examples 1-11, wherein to operate in the bonded group comprises operating in a home theater mode.

(Example 13) A playback device comprising: radio circuitry comprising a first radio and a second radio; at least one antenna coupled to the radio circuitry; at least one processor; at least one non-transitory computer-readable medium; and program instructions stored on the non-transitory computer-readable medium that are executable by the at least one processor such that the playback device is configured to connect, using the first radio, to a first wireless network; receive an instruction to form a bonded group, wherein the bonded group comprises the playback device and the plurality of satellite playback devices; identify, based on one or more capabilities of the plurality of satellite playback devices, a first subset of the plurality of satellite playback devices and a second subset of the plurality of satellite playback devices; identify, based at least in part on the capabilities of the second subset of the plurality of satellite playback devices, one or more parameters for a second wireless network over which to communicate with the second subset of the plurality of satellite playback devices; establish, using the second radio, the second wireless network in accordance with the one or more parameters identified for the second wireless network; receive an audio stream including multi-channel audio content; communicate, over the first wireless network, at least one first audio channel of the multi-channel audio content to the first subset of satellite playback devices for playback by the first subset of the plurality of satellite playback devices; and communicate, over the second wireless network, at least one second audio channel of the multi-channel audio content to the second subset of satellite playback devices for playback by the second subset of the plurality of satellite playback devices in synchrony with playback of the at least one first audio channel by the first subset of the plurality of satellite playback devices.

(Example 14) The playback device of Example 13, wherein the one or more capabilities of the plurality of satellite playback devices include an operating frequency band for wireless communications, and a number of audio channels to be rendered for playback by each satellite playback device.

(Example 15) The playback device of Example 14, wherein the first subset of the plurality of satellite playback devices are capable of rendering fewer audio channels than the second subset of the plurality of satellite playback devices.

(Example 16) The playback device of Example 14, wherein the second subset of the plurality of satellite playback devices are capable of communicating over a 6 GHz operating frequency band; and wherein the program instructions that are executable by the at least one processor such that the playback device is configured to establish the second wireless network include program instructions that are executable by the at least one processor such that the playback device is configured to: establish the second wireless network in the 6 GHz operating frequency band.

(Example 17) The playback device of Example 16, wherein the first wireless network is in one of a 2.4 GHz operating frequency band and a 5 GHz operating frequency band.

(Example 18) The playback device of any one of Examples 13-17, wherein the at least one non-transitory computer-readable medium further comprises program instructions that are executable by the at least one processor such that the playback device is configured to: render at least one third audio channel of the multi-channel audio content for playback in synchrony with playback of the at least one first audio channel by the first subset of satellite playback devices and playback of the at least one second audio channel by the second subset of satellite playback devices.

(Example 19) The playback device of Example 18, wherein the playback device is a soundbar.

(Example 20) The playback device of Example 19, wherein the multi-channel audio content is synchronized to video content, and wherein an audio delay between the multi-channel audio content received by the playback device and playback of the at least one first audio channel by the first subset of satellite playback devices and playback of the at least one second audio channel by the second subset of satellite playback devices is less than 40 ms.

(Example 21) The playback device of any one of Examples 13-20, wherein the program instructions that are executable by the at least one processor such that the playback device is configured to receive an instruction to form the bonded group include program instructions that are executable by the at least one processor such that the playback device is configured to: receive an instruction to operate in a home theater mode.

(Example 22) A method of configuring a home theater system including a first playback device and a plurality of satellite playback devices, the method comprising: connecting to a first wireless network in a first frequency band, wherein the first wireless network includes a WI-FI Access Point (AP); receiving an instruction to form a bonded group, wherein the bonded group comprises the first playback device and the plurality of satellite playback devices; identifying a subset of the plurality of satellite playback devices as being capable of wireless communication in a second frequency band different from the first frequency band; establishing a second wireless network in the second frequency band; establishing a communications link with each satellite playback device in the subset of satellite playback devices over the second wireless network; establishing a communications link with each remaining satellite playback device of the plurality of satellite playback devices over the first wireless network; receiving an audio stream including multi-channel audio content; communicating, over the second wireless network, at least one first audio channel of the multi-channel audio content to the subset of the plurality of satellite playback devices for playback by the subset of the plurality of satellite playback devices; and communicating, over the first wireless network, at least one second audio channel of the multi-channel audio content to the remaining satellite playback devices for playback in synchrony with playback of the at least one first audio channel by the subset of the plurality of satellite playback devices.

(Example 23) The method of Example 22, wherein the first frequency band is a 5 GHz frequency band and the second frequency band is a 6 GHz frequency band.

(Example 24) The method of one of Examples 22 and 23, wherein receiving the instruction to form the bonded group comprises receiving an instruction to operate in a home theater mode.

(Example 25) A playback device comprising: radio circuitry including a first radio and a second radio; at least one antenna coupled to the radio circuitry; at least one processor; and at least one non-transitory computer-readable medium storing program instructions that are executable by the at least one processor to control the playback device to operate in a bonded group including the playback device and one or more satellite playback devices, to operate in a bonded group comprising to coordinate a playback session including playback of multi-channel audio content by the one or more satellite playback devices, the one or more satellite playback devices being connected to a first wireless network established using the first radio, wherein to coordinate includes to transmit data representing one or more audio channels of the multi-channel audio content to the one or more satellite playback devices over the first wireless network; receive a first swap signal indicating to transition the playback session to a portable playback device; while connected to a second wireless network established using the second radio and without interfering with the second wireless network, modify the first wireless network based on at least a network capability of the portable playback device and one or more parameters of the second wireless network to enable the portable playback device to connect to the first wireless network; after the portable playback device has connected to the first wireless network, form (e.g., temporarily form) a first synchrony group including the portable playback device and the one or more satellite playback devices, wherein forming the first synchrony group causes the portable playback device to start playing the multi-channel audio content of the playback session via one or more transducers and one or more amplifiers; and after forming (e.g., immediately after forming) the first synchrony group, remove the one or more satellite playback devices from the first synchrony group to stop playback of the one or more audio channels of the multi-channel audio content on the one or more satellite playback devices.

(Example 26) The playback device of Example 25, wherein the at least one non-transitory computer-readable medium further comprises program instructions that are executable by the at least one processor to control the playback device to: transition the one or more satellite playback devices from the first wireless network onto the second wireless network.

(Example 27) The playback device of one of Examples 25 and 26, wherein the portable playback device is a wearable playback device.

(Example 28) The playback device of any one of Examples 25-27, wherein the one or more parameters of the second wireless network include a frequency band of operation of the second wireless network.

(Example 29) The playback device of Example 28, wherein the frequency band of operation of the second wireless network is a 5 GHz frequency band, wherein the second wireless network operates in a first region of the 5 GHz frequency band, and wherein the program instructions that are executable by the at least one processor such that the playback device is configured to modify the first wireless network include program instructions that are executable by the at least one processor such that the playback device is configured to: modify a first frequency band of operation of the first wireless network to reestablish the first wireless network in a second region of the 5 GHz frequency band, the second region being non-overlapping with the first region.

(Example 30) The playback device of Example 29, wherein the first frequency band of operation of the first wireless network is a 6 GHz frequency band.

(Example 31) The playback device of any one of Examples 25-30, wherein the program instructions that are executable by the at least one processor such that the playback device is configured to coordinate the playback session include program instructions that are executable by the at least one processor such that the playback device is configured to: transmit, over the second wireless network, data representing at least one audio channel of the multi-channel audio content to at least one satellite playback device connected to the second wireless network.

(Example 32) The playback device of any one of Examples 25-31, wherein to operate in the bonded group comprises operating in a home theater mode.

(Example 33) The playback device of any one of Examples 25-32, wherein the playback device is a soundbar.

(Example 34) The playback device of any one of Examples 25-33, wherein the at least one network capability of the portable playback device includes at least one of an operating frequency band of a wireless network interface of the portable playback device or a communications channel width.

(Example 35) The playback device of any one of Examples 25-34, wherein the at least one non-transitory computer-readable medium further comprises program instructions that are executable by the at least one processor to control the playback device to: receive a second swap signal indicating to transition the playback session from the portable playback device to the one or more satellite playback devices; form (e.g., temporarily form) a second synchrony group including the portable playback device and the one or more satellite playback devices, wherein forming the second synchrony group causes the one or more satellite playback devices to start playing the one or more audio channels of the multi-channel audio content of the playback session; and after (e.g., immediately after) forming the second synchrony group, remove the portable playback device from the second synchrony group to stop playback of the multi-channel audio content on the portable playback device.

(Example 36) A playback device comprising: radio circuitry including a first radio and a second radio; at least one antenna coupled to the radio circuitry; at least one processor; and at least one non-transitory computer-readable medium storing program instructions that are executable by the at least one processor to control the playback device to operate in a bonded group including the playback device and one or more satellite playback devices, to operate in a bonded group comprising to coordinate a playback session including playback of multi-channel audio content by the plurality of satellite playback devices, a first subset of the plurality of satellite playback devices being connected to a first wireless network established by the first radio and a second subset of the plurality of satellite playback devices being connected to a second wireless network established by the second radio, wherein to coordinate includes to transmit, over the first wireless network, first data representing one or more first audio channels of the multi-channel audio content to the first subset of the plurality of satellite playback devices for playback by the first subset of the plurality of satellite playback devices and to transmit, over the second wireless network, second data representing one or more second audio channels of the multi-channel audio content to the second subset of the plurality of satellite playback devices for playback by the second subset of the plurality of playback devices in synchrony with playback of the one or more first audio channels by the first subset of the plurality of satellite playback devices; receive a first swap signal indicating to transition the playback session to a portable playback device; without interfering with the second wireless network, reconfigure the first wireless network based on at least a network capability of the portable playback device and one or more parameters of the second wireless network to enable the portable playback device to connect to the first wireless network; establish a communications link to the portable playback device over the first wireless network; and transition the playback session to the portable playback device, including to transmit the multi-channel audio content to the portable playback device for playback by the portable playback device, and to stop transmitting the first data to the first subset of the plurality of playback device and the second data to the second subset of the plurality of playback devices.

(Example 37) The playback device of Example 36, wherein the program instructions that are executable by the at least one processor such that the playback device is configured to transition the playback session to the portable playback device include program instructions that are executable by the at least one processor such that the playback device is configured to: transition the first subset of the plurality of satellite playback devices from the first wireless network onto the second wireless network.

(Example 38) The playback device of Example 37, wherein at least one non-transitory computer-readable medium further comprises program instructions that are executable by the at least one processor to control the playback device to: receive a second swap signal indicating to transition the playback session from the portable playback device to the plurality of satellite playback devices; and transition the playback session to the plurality of satellite playback devices, including to stop transmitting the multi-channel audio content to the portable playback device, transmit the first data to the first subset of the plurality of playback device for playback by the first subset of the plurality of satellite playback devices; and transmit the second data to the second subset of the plurality of playback devices for playback by the second subset of the plurality of playback devices in synchrony with playback of the one or more first audio channels by the first subset of the plurality of satellite playback devices.

(Example 39) The playback device of Example 38, wherein the program instructions that are executable by the at least one processor such that the playback device is configured to transition the playback session from the portable playback device to the plurality of satellite playback devices include program instructions that are executable by the at least one processor such that the playback device is configured to: reconfigure the first wireless network based on at least one network capability of the first subset of the plurality of satellite playback devices; and transition the first subset of the plurality of satellite playback devices from the second wireless network onto the first wireless network.

(Example 40) The playback device of any one of Examples 36-39, wherein the one or more parameters of the second wireless network include an operating frequency band.

(Example 41) The playback device of Example 40, wherein an initial operating frequency band of the first wireless network is within a 6 GHz frequency band, wherein the operating frequency band of the second wireless network is a first region of a 5 GHz frequency band, and wherein the program instructions that are executable by the at least one processor such that the playback device is configured to reconfigure the first wireless network include program instructions that are executable by the at least one processor such that the playback device is configured to: reestablish the first wireless network with an operating frequency band corresponding to a second region of the 5 GHz frequency band, the second region being non-overlapping with the first region.

(Example 42) The playback device of Example 40, wherein an operating frequency band of the first wireless network is a first region of a 5 GHz frequency band, wherein the operating frequency band of the second wireless network is a second region of the 5 GHZ frequency band, and wherein the program instructions that are executable by the at least one processor such that the playback device is configured to reconfigure the first wireless network include program instructions that are executable by the at least one processor such that the playback device is configured to: reconfigure a communications channel width of the first wireless network based on the network capability of the portable playback device.

(Example 43) The playback device of any one of Examples 36-43, wherein the at least one non-transitory computer-readable medium further comprises program instructions that are executable by the at least one processor to control the playback device to playback one or more other audio channels of the multi-channel audio content in synchrony with playback of the one or more first audio channels by the first subset of the plurality of satellite playback devices and playback of the one or more second audio channels by the second subset of the plurality of playback devices during the playback session; and wherein the program instructions that are executable by the at least one processor such that the playback device is configured to transition the playback session include program instructions that are executable by the at least one processor such that the playback device is configured to stop playing the one or more other audio channels of the multi-channel audio content.

(Example 44) The playback device of any one of Examples 36-43, wherein the portable playback device is a wearable playback device.

(Example 45) The playback device of any one of Examples 36-44, wherein the playback device is a soundbar.

(Example 46) A method of managing a playback session in a home theater environment, the method comprising: receiving an audio stream including multi-channel audio content corresponding to the playback session; streaming, over a first wireless network in a first frequency band, at least one first audio channel of the multi-channel audio content to at least one first satellite playback device for playback by the at least one first satellite playback device; streaming, over a second wireless network, at least one second audio channel of the multi-channel audio content to at least one second satellite playback device for playback by the at least one second satellite playback device in synchrony with playback of the at least one first audio channel by the at least one first playback device, the second wireless network being in a second frequency band and including a WI-FI Access Point (AP); receiving a swap signal indicating to transition the playback session to a portable playback device; reconfiguring the first wireless network based on a network capability of the portable playback device and one or more parameters of the second wireless network to enable the portable playback device to connect to the first wireless network; forming (e.g., temporarily forming) a first synchrony group including the portable playback device, the at least one first satellite playback device, and the at least one second satellite playback device, wherein forming the first synchrony group causes the portable playback device to start playing the multi-channel audio content of the playback session via one or more transducers and one or more amplifiers; after (e.g., immediately after) forming the first synchrony group, removing the at least one first satellite playback device and the at least one second satellite playback device from the first synchrony group to stop playback of the at least one first audio channel by the at least one first satellite playback device and playback of the at least one second audio channel by the at least one second satellite playback device; and transitioning the at least one second satellite playback device from the first wireless network onto the second wireless network.

(Example 47) The method of Example 46), wherein the one or more parameters of the second wireless network include a frequency band of operation of the second wireless network.

(Example 48) The method of Example 47, wherein the frequency band of operation of the second wireless network is a 5 GHz frequency band, wherein the second wireless network operates in a first region of the 5 GHz frequency band, and wherein reconfiguring the first wireless network includes: modifying a first frequency band of operation of the first wireless network to reestablish the first wireless network in a second region of the 5 GHZ frequency band, the second region being non-overlapping with the first region.

(Example 49) The method of Example 48, wherein the first frequency band of operation of the first wireless network is a 6 GHz frequency band.

(Example 50) The method of any one of Examples 46-49, wherein the network capability of the portable playback device includes at least one of an operating frequency band of a wireless network interface of the portable playback device or a communications channel width.

(Example 51) The method of any one of Examples 46-50, further comprising: receiving a second swap signal indicating to transition the playback session from the portable playback device to the at least one first satellite playback device and the at least one second satellite playback device; forming (e.g., temporarily forming) a second synchrony group including the portable playback device, the at least one first satellite playback device, and the at least one second satellite playback device, wherein forming the second synchrony group causes the at least one first satellite playback device and the at least one second satellite playback device to start playing the at least one first audio channel of the multi-channel audio content of the playback session and the at least one second audio channel of the multi-channel audio content of the playback session, respectively; and after (e.g., immediately after) forming the second synchrony group, removing the portable playback device from the second synchrony group to stop playback of the multi-channel audio content on the portable playback device.

(Example 52) A method for a playback device, the method comprising, while in a group comprising a plurality of satellite playback devices: connecting, using a first radio of the playback device, to a first wireless network, establishing, using a second radio of the playback device, a second wireless network, receiving an audio stream including multi-channel audio content, communicating at least one first audio channel of the multi-channel audio content to a first subset of satellite playback devices over the first wireless network, and communicating at least one second audio channel of the multi-channel audio content to a second subset of satellite playback devices over the second wireless network.

(Example 53) The method of Example 52, further comprising rendering at least one third audio channel of the multi-channel audio content in synchrony with rendering of the at least one first audio channel by the first subset of satellite playback devices and rendering of the at least one second audio channel by the second subset of satellite playback devices.

(Example 54) The method of one of Examples 52 or 53, further comprising identifying, based on one or more capabilities of the plurality of satellite playback devices, the first subset of the plurality of satellite playback devices and the second subset of the plurality of satellite playback devices.

(Example 55) The method of Example 54, further comprising identifying, based at least in part on the capabilities of the second subset of the plurality of satellite playback devices, one or more parameters for the second wireless network over which to communicate with the second subset of the plurality of satellite playback devices.

(Example 56) The method of Example 55, wherein establishing the second wireless network comprises establishing the second wireless network in accordance with the one or more parameters identified for the second wireless network.

(Example 57) The method of any one of Examples 52-56, further comprising playing back, by the plurality of satellite playback devices and the playback device, the audio content in synchrony.

(Example 58) The method of any one of Examples 52-57, wherein the first wireless network is in a first frequency band, wherein the first wireless network includes a WIFI Access Point (AP) and the second wireless network is established in a second frequency band.

(Example 59) The method of Example 54 alone or in combination with any of Examples 52, 53, or 55-58, wherein identifying the one or more capabilities of the plurality of satellite devices comprises identifying satellite playback devices that are capable of wireless communication in a second frequency band different from the first frequency band.

(Example 60) The method of any one of Examples 52-59, further comprising, before communicating the at least one audio channel to the first and second subsets of satellite playback devices, establishing first and second communication links with the first and second subsets of satellite playback devices over the first and second wireless networks, respectively.

(Example 61) The method of any one of Examples 52-60, further comprising, before establishing the second wireless network, receiving an instruction to form a bonded group, wherein the bonded group comprises the first playback device and the plurality of satellite playback devices.

(Example 62) The method of Example 54, alone or in combination with any of Examples 52, 53, or 55-61, wherein the one or more capabilities of the plurality of satellite playback devices include one or more communication frequency bands, and wherein the identifying the first and second subsets of the plurality of satellite playback devices includes identifying the second subset of the plurality of satellite playback devices as being capable of communicating over a 6 GHz frequency band.

(Example 63) The method of Example 54 alone or in combination with any of Examples 52, 53, or 55-62, wherein the one or more capability of the plurality of satellite playback devices includes a number of audio channels to be rendered for playback by each satellite playback device.

(Example 64) The method of any one of Examples 52-63, wherein the first subset of the plurality of satellite playback devices are capable of rendering fewer audio channels than the second subset of the plurality of satellite playback devices.

(Example 65) The method of any one of Examples 52-64, wherein the first wireless network is in one of a 2.4 GHz frequency band and a 5 GHz frequency band.

(Example 66) The method of any one of Examples 52-65, wherein the playback device comprises at least one a multi-band antenna configured to operate in two or more frequency bands.

(Example 67) The method of any one of Examples 52-66, wherein the first wireless network includes a WI-FI Access Point (AP).

(Example 68) The method of any one of Examples 52-67, wherein the multi-channel audio content is synchronized to video content, and wherein an audio delay between the multi-channel audio content received by the playback device and rendering of the at least one first audio channel by the first subset of satellite playback devices and rendering of the at least one second audio channel by the second subset of satellite playback devices is less than 40 ms.

(Example 69) The method of any one of Examples 52-68, wherein to operate in the group comprises operating in a home theatre mode.

(Example 70) A playback device comprising: radio circuitry comprising a first radio and a second radio, at least one antenna coupled to the radio circuitry, at least one processor, and at least one non-transitory computer-readable medium storing program instructions that are executable by the at least one processor such that the playback device is configured to perform the method of any one of Examples 52-69.

(Example 71) A method for a playback device, the method comprising: coordinating a playback session including playback of multi-channel audio content by one or more satellite playback devices in a bonded group with the playback device, at least a subset of the one or more satellite playback devices being connected to a first wireless network established using the first radio, wherein coordinating the playback session includes transmitting data representing one or more audio channels of multi-channel audio content to the at least the subset of the one or more satellite playback devices over the first wireless network; after receiving an indication to transition the playback session to a portable playback device and while connected to a second wireless network established using the second radio and without interfering with the second wireless network, modifying the first wireless network based on at least a network capability of the portable playback device and one or more parameters of the second wireless network to enable the portable playback device to connect to the first wireless network; and transitioning the playback session to the portable playback device, wherein transitioning the playback session to the portable playback device includes transmitting the multi-channel audio content to the portable playback device for playback by the portable device.

(Example 72) The method of Example 71, wherein the indication to transition the playback session to the portable device comprises a swap signal.

(Example 73) The method of one of Examples 71 or 72, wherein a first subset of satellite playback devices are connected to the first wireless network established using the first radio, and a second subset of satellite playback devices are connected to the second wireless network established using a second radio of the playback device, and wherein transmitting data representing one or more audio channels of the multi-channel audio content includes: transmitting, over the first network, first data representing one or more audio channels to the first subset of satellite playback devices, and transmitting, over the second network, second data representing one or more audio channels to the second subset of satellite playback devices.

(Example 74) The method of one of Examples 71 to 73, further comprising, before transitioning the playback session to the portable playback device, establishing a communications link to the portable playback device over the first wireless network.

(Example 75) The method of one of Examples 71 to 74, wherein transitioning the playback session to the portable playback device further includes stopping transmitting the one or more audio channels to the satellite playback devices.

(Example 76) The method of one of Examples 71 to 75, wherein transitioning the playback session to the portable playback device further includes: after the portable playback device has connected to the first wireless network, forming a synchrony group including the portable playback device and the one or more satellite playback devices, wherein forming the synchrony group causes the portable playback device to start playing the multi-channel audio content of the playback session via one or more transducers and one or more amplifiers; and after forming the synchrony group, removing the one or more satellite playback devices from the first synchrony group to stop playback of the one or more audio channels of the multi-channel audio content on the one or more satellite playback devices.

(Example 77) The method of one of Examples 71 to 76, wherein coordinating the playback session further includes: receiving an audio stream including multi-channel audio content corresponding to the playback session, streaming, over the first wireless network in a first frequency band, at least one first audio channel of the multi-channel audio content to at least one first satellite playback device for playback by the at least one first satellite playback device, and streaming, over the second wireless network, at least one second audio channel of the multi-channel audio content to at least one second satellite playback device for playback by the at least one second satellite playback device in synchrony with playback of the at least one first audio channel by the at least one first playback device, the second wireless network being in a second frequency band and including a WI-FI Access Point (AP).

(Example 78) The method of one of Examples 71 to 77, further comprising: receiving a second indication to transition the playback session from the portable playback device to the bonded group; forming a second synchrony group including the portable playback device and the one or more satellite playback devices and causing the one or more satellite playback devices to start playing the one or more audio channels of the multi-channel audio content of the playback session; and after forming the second synchrony group, removing the portable playback device from the second synchrony group to stop playback of the multi-channel audio content on the portable playback device.

(Example 79) The method of one of Examples 71 to 77, further comprising: receiving a second indication to transition the playback session from the portable playback device to the plurality of satellite playback devices; and transitioning the playback session to the plurality of satellite playback devices by: stopping transmitting the multi-channel audio content to the portable playback device, transmitting the one or more audio channels to the at least the subset of the plurality of playback devices, and transmitting second one or more channels to a second subset of the plurality of playback devices for playback by the second subset of the plurality of playback devices in synchrony with playback of the one or more first audio channels by the first subset of the plurality of satellite playback devices.

(Example 80) The method of Example 79, further comprising, after forming the second synchrony group, removing the portable playback device from the second synchrony group.

(Example 81) The method of one of Examples 71 to 80, further comprising transitioning the at least the subset of the plurality of satellite playback devices from the first wireless network onto the second wireless network.

(Example 82) The method of one of Examples 78 to 81, wherein transitioning the playback session to the plurality of satellite playback devices comprises reconfiguring the first wireless network based on at least one network capability of at least a subset of the plurality of satellite playback devices, and transitioning the at least the subset of satellite playback devices from the second wireless network to the first wireless network.

(Example 83) The method of one of Examples 71 to 82, wherein the frequency band of operation of the second wireless network is a 5GHz frequency band, and wherein modifying the first wireless network includes modifying a first frequency band of operation of the first wireless network to reestablish the first wireless network in a second region of the 5 Ghz frequency band, the second region being non-overlapping with the first region.

(Example 84) The method of one of Examples 71 to 83, wherein the first wireless network is a 6 GHz frequency band.

(Example 85) The method of one of Examples 71 to 84, wherein the first and second networks are in first and second regions of the 5 Ghz frequency band, the method further comprising reconfiguring a communications channel width of the first wireless network based on the network capability of the portable playback device.

(Example 85) The method of one of Examples 78 to 84, further comprising transmitting, over the second wireless network, at least one audio channel to at least one satellite playback devices.

(Example 86) The method of one of Examples 71 to 85, wherein the at least one network capability of the portable playback device comprises at least one of a communications channel width, and an operating frequency band of a wireless network interface of the portable device.

(Example 87) The method of one of Examples 71 to 86, wherein the one or more parameters of the second wireless network includes a frequency band of operation of the second wireless network.

(Example 88) The method of one of Examples 71 to 87, wherein forming the first synchrony group causes the portable playback device to start playing the multi-channel audio content of the playback session via one or more transducers and one or more amplifiers.

(Example 89) The method of one of Examples 71 to 88, further comprising, after transitioning the playback session to the portable playback device, transitioning the at least the subset of satellite playback devices from the first wireless network onto the second wireless network.

(Example 90) The method of one of Examples 71 to 89, wherein the portable playback device is a wearable playback device.

1. A method for operating a playback device, while in a group comprising the playback device and a plurality of satellite playback devices, the method comprising:
connecting, using a first radio of the playback device, the playback device to a first wireless network;
identifying, based on one or more capabilities of the plurality of satellite playback devices, a first subset of the plurality of satellite playback devices and a second subset of the plurality of satellite playback devices;
establishing, using a second radio of the playback device, a second wireless network between the playback device and the second subset of the plurality of playback devices;
receiving, by the playback device, an audio stream including multi-channel audio content;
communicating at least one first audio channel of the multi-channel audio content from the playback device to [[a]] the first subset of satellite playback devices over the first wireless network; and
communicating at least one second audio channel of the multi-channel audio content from the playback device to [[a]] the second subset of satellite playback devices over the second wireless network; and
rendering, by the playback device, at least one third audio channel of the multi-channel audio content in synchrony with rendering of the at least one first audio channel by the first subset of satellite playback devices and rendering of the at least one second audio channel by the second subset of satellite playback devices.

2. (canceled)

3. (canceled)

4. The method of claim of claim 1, wherein establishing the second wireless network comprises:
identifying, based at least in part on the capabilities of the second subset of the plurality of satellite playback devices, one or more parameters for the second wireless network and establishing the second wireless network in accordance with the one or more parameters identified for the second wireless network.

5. (canceled)

6. (canceled)

7. The method of claim 1, wherein the first wireless network is in a first frequency band, wherein the first wireless network includes a WIFI Access Point (AP), and wherein the second wireless network is established in a second frequency band different from the first frequency band.

8. The method of claim other claim 7, wherein identifying the one or more capabilities second subset of the plurality of satellite devices comprises identifying satellite playback devices that are capable of wireless communication in [[a]] the second frequency band

9. (canceled)

10. (canceled)

11. The method of claim 3, alone or in combination with any other claim 8, wherein the one or more capabilities of the plurality of satellite playback devices include one or more communication frequency bands, and wherein the identifying the first and second subset of the plurality of satellite playback devices includes:
identifying the second subset of the plurality of satellite playback devices as being capable of communicating over a 6 GHz frequency band.

12. The method of claim claim 1, wherein the one or more capability of the plurality of satellite playback devices includes a number of audio channels to be rendered for playback by each satellite playback device; and
wherein the first subset of the plurality of satellite playback devices are capable of rendering fewer audio channels than the second subset of the plurality of satellite playback devices.

13. (canceled)

14. The method of claim 11, wherein the first wireless network is in one of a 2.4 GHz frequency band and or a 5 GHz frequency band; and
wherein the second wireless network is established in the 6 GHz frequency band.

15. (canceled)

16. (canceled)

17. (canceled)

18. (canceled)

19. A playback device comprising:
radio circuitry comprising a first radio and a second radio;
at least one antenna coupled to the radio circuitry;
at least one processor; and
at least one non-transitory computer-readable medium storing program instructions that are executable by the at least one processor to control the playback device to operate in a bonded group comprising the playback device and a plurality of satellite playback device, to operate in the bonded group comprising to:
connect, using the first radio, to a first wireless network;
establish, using the second radio, a second wireless network;
receive an audio stream including multi-channel audio content;
identify, based on one or more capabilities of the plurality of satellite playback devices, a first subset of the plurality of satellite playback devices and a second subset of the plurality of satellite playback devices;
communicate at least one first audio channel of the multi-channel audio content to the first subset of satellite playback devices over the first wireless network;
communicate at least one second audio channel of the multi-channel audio content to the second subset of satellite playback devices over the second wireless network; and
render at least one third audio channel of the multi-channel audio content in synchrony with rendering of the at least one first audio channel by the first subset of satellite playback devices and rendering of the at least one second audio channel by the second subset of satellite playback devices.

20. A method for a playback device, the method comprising:
coordinating a playback session including playback of multi-channel audio content by one or more satellite playback devices in a bonded group with the playback device, at least a subset of the one or more satellite playback devices being connected to a first wireless network established using the first radio, wherein coordinating the playback session includes transmitting data representing one or more audio channels of multi-channel audio content to the subset of the one or more satellite playback devices over the first wireless network;
after receiving an indication to transition the playback session to a portable playback device and while connected to a second wireless network established using the second radio and without interfering with the second wireless network, modifying the first wireless network based on at least a network capability of the portable playback device and one or more parameters of the second wireless network to enable the portable playback device to connect to the first wireless network; and
transitioning the playback session to the portable playback device, wherein transitioning the playback session to the portable playback device includes transmitting the multi-channel audio content to the portable playback device for playback by the portable device.

21. The method of claim 20, wherein the indication to transition the playback session to the portable device comprises a swap signal.

22. (canceled)

23. (canceled)

24. The method of claim 20, wherein transitioning the playback session to the portable playback device further includes:
stopping transmitting the one or more audio channels to the subset of the plurality of satellite playback devices.

25. The method of one of claims 20 to 24 claim 20, wherein transitioning the playback session to the portable playback device further includes:
after the portable playback device has connected to the first wireless network, forming a synchrony group including the portable playback device and the one or more satellite playback devices, wherein forming the synchrony group causes the portable playback device to start playing the multi-channel audio content of the playback session via one or more transducers and one or more amplifiers; and
after forming the synchrony group, removing the one or more satellite playback devices from the first synchrony group to stop playback of the one or more audio channels of the multi-channel audio content on the one or more satellite playback devices.

26. (canceled)

27. The method of claim 20, further comprising:
receiving a second indication to transition the playback session from the portable playback device to the bonded group;
forming a second synchrony group including the portable playback device and the one or more satellite playback devices and causing the one or more satellite playback devices to start playing the one or more audio channels of the multi-channel audio content of the playback session; and
after forming the second synchrony group, removing the portable playback device from the second synchrony group to stop playback of the multi-channel audio content on the portable playback device.

28. (canceled)

29. (canceled)

30. (canceled)

31. (canceled)

32. (canceled)

33. (canceled)

34. The method of one of claims 20 to 33 claim 20, wherein the first and second networks are in first and second regions of the 5Ghz frequency band, the method further comprising reconfiguring a communications channel width of the first wireless network based on the network capability of the portable playback device.

35. (canceled)

36. (canceled)

37. (canceled)

38. (canceled)

39. (canceled)

40. (canceled)

41. The playback device of claim 19, wherein to establish the second wireless network comprises to:
identify one or more parameters for the second wireless network based on (i) at least one of one or more parameters for the first wireless network or (ii) the one or more capabilities of the plurality of satellite playback devices; and
establish, using the second radio, the second wireless network in accordance with the one or more parameters identified for the second wireless network.

42. The playback device of claim 41, wherein the one or more parameters of the first wireless network include a frequency band of the first wireless network.

43. The playback device of claim 19, wherein the one or more capabilities of the plurality of satellite playback devices include one or more communication frequency bands;
wherein to identify the first and second subsets of the plurality of satellite playback devices comprises to identify the second subset of the plurality of satellite playback devices as being capable of communicating over a 6 GHz frequency band; and
wherein to establish the second wireless network comprises to establish the second wireless network in the 6 GHz frequency band.

44. The playback device of claim 43, wherein the first wireless network is in one of a 2.4 GHz frequency band and a 5 GHz frequency band; and
wherein the first wireless network includes a WIFI Access Point (AP).

45. The playback device of claim 44, wherein the at least one antenna is a multi-band antenna configured to operate in two or more frequency bands.

46. The playback device of claim 19, wherein to operate in the bonded group comprises operating in a home theatre mode;
wherein the multi-channel audio content is synchronized to video content; and
wherein an audio delay between the multi-channel audio content received by the playback device and rendering of the at least one first audio channel by the first subset of satellite playback devices and rendering of the at least one second audio channel by the second subset of satellite playback devices is less than 40ms.
